(19) United States
(12) Patent Application Publication
(10) Pub. No.: US 2011/0285817 A1
(43) Pub. Date: Nov. 24, 2011

(54) STEREO IMAGE DATA TRANSMITTING APPARATUS, STEREO IMAGE DATA TRANSMITTING METHOD, STEREO IMAGE DATA RECEIVING APPARATUS, AND STEREO IMAGE DATA RECEIVING METHOD

(75) Inventor: Ikuo Tsukagoshi, Tokyo (JP)

(73) Assignee: SONY CORPORATION, Tokyo (JP)

(21) Appl. No.: 13/109,067

(22) Filed: May 17, 2011

(30) Foreign Application Priority Data
May 24, 2010 (JP) P2010-118847

(51) Int. Cl. H04N 13/00

(52) U.S. Cl. 348/43; 348/E13.001

(57) ABSTRACT

A stereo image data transmitting apparatus includes an image data output unit configured to output stereo image data including left-eye image data and right-eye image data, a superimposition information data output unit configured to output data of superimposition information that is to be superimposed on images based on the left-eye image data and the right-eye image data, a disparity information output unit configured to output disparity information for giving disparity by shifting the superimposition information that is to be superimposed on the images based on the left-eye image data and the right-eye image data, and a data transmitting unit configured to transmit a multiplexed data stream including a first data stream and a second data stream, the first data stream including the stereo image data, the second data stream including the data of the superimposition information and the disparity information.

### CROSS-REFERENCE TO RELATED APPLICATION

The present application claims priority from Japanese Patent Application No. JP 2010-118847 filed in the Japanese Patent Office on May 24, 2010, the entire content of which is incorporated herein by reference.

### BACKGROUND

The present disclosure relates to a stereo image data transmitting apparatus, a stereo image data transmitting method, a stereo image data receiving apparatus, and a stereo image data receiving method, and particularly relates to a stereo image data transmitting apparatus and the like capable of favorably performing display of superimposition information, such as captions.

For example, a method for transmitting stereo image data using television airwaves is suggested in Japanese Unexamined Patent Application Publication No. 2005-6114. In this case, stereo image data including left-eye image data and right-eye image data is transmitted, and stereo image display using binocular disparity is performed in a television receiver.

FIG. 25 illustrates a relationship between the display positions of left and right images of an object on a screen and the reproduction position of the stereo image formed therefrom in stereo image display using binocular disparity. For example, regarding an object A, a left image La of which is displayed so as to be shifted to the right side and a right image Ra of which is displayed so as to be shifted to the left side on the screen, as illustrated in the figure, left and right lines of sight cross in front of a screen surface, and thus the reproduction position of the stereo image thereof is in front of the screen surface. DPa represents a disparity vector in the horizontal direction regarding the object A.

Also, for example, regarding an object B, a left image Lb and a right image Rb of which are displayed at the same position on the screen, as illustrated in the figure, left and right lines of sight cross on the screen surface, and thus the reproduction position of the stereo image thereof is on the screen surface. Furthermore, for example, regarding an object C, a left image Lc of which is displayed so as to be shifted to the left side and a right image Rc of which is displayed so as to be shifted to the right side on the screen, as illustrated in the figure, left and right lines of sight cross behind the screen surface, and thus the reproduction position of the stereo image thereof is behind the screen surface. DPc represents a disparity vector in the horizontal direction regarding the object C.

### SUMMARY

As described above, in stereo image display, a viewer normally recognizes perspective in a stereo image using binocular disparity. Regarding superimposition information that is to be superimposed on an image, such as captions, for example, it is expected to be rendered in conjunction with stereo image display not only in a two-dimensional space but also in three-dimensional perspective.

For example, in the case of performing superimposition display (overlay display) of a caption on an image, a viewer may feel perspective inconsistency unless the caption is displayed in front of the nearest object in the image in terms of perspective. Also, in the case of performing superimposition display of other graphics information or text information on an image, it is expected that disparity adjustment is to be performed in accordance with the perspective of individual objects in the image and perspective consistency is to be maintained.

Accordingly, it is desirable to maintain perspective consistency with individual objects in an image in display of superimposition information, such as captions.

According to an embodiment of the present disclosure, there is provided a stereo image data transmitting apparatus including: an image data output unit configured to output stereo image data including left-eye image data and right-eye image data; a superimposition information data output unit configured to output data of superimposition information that is to be superimposed on images based on the left-eye image data and the right-eye image data; a disparity information output unit configured to output disparity information for giving disparity by shifting the superimposition information that is to be superimposed on the images based on the left-eye image data and the right-eye image data; and a data transmitting unit configured to transmit a multiplexed data stream including a first data stream and a second data stream, the first data stream including the stereo image data output from the image data output unit, the second data stream including the data of the superimposition information output from the superimposition information data output unit and the disparity information output from the disparity information output unit. Pieces of data of a certain number of pieces of superimposition information that are to be displayed on the same screen are sequentially arranged in the second data stream. The disparity information is inserted as management information of the certain number of pieces of superimposition information into the second data stream.

In this embodiment of the present disclosure, the image data output unit outputs stereo image data including left-eye image data and right-eye image data. Also, the superimposition information data output unit outputs data of superimposition information that is to be superimposed on images based on the left-eye image data and the right-eye image data. Here, the superimposition information includes information such as captions superimposed on an image. For example, the data of the superimposition information is caption sentence data based on an ARIB method. Also, the disparity information output unit outputs disparity information for giving disparity by shifting the superimposition information that is to be superimposed on the images based on the left-eye image data and the right-eye image data.

Then, the data transmitting unit transmits a multiplexed data stream including a first data stream and a second data stream. The first data stream includes stereo image data output from the image data output unit. Also, the second data stream includes the data of superimposition information output from the superimposition information data output unit and the disparity information output from the disparity information output unit.

In the second data stream, pieces of data of a certain number of pieces of superimposition information that are to be displayed on the same screen are sequentially arranged. In the second data stream, disparity information is inserted as management information of the certain number of pieces of superimposition information. For example, the data of superimposition information is caption sentence data based on an ARIB method, and the disparity information is inserted as caption management data into the second data stream. In this case, the disparity information is given as an 8-unit code, for example.

For example, a certain number of pieces of individual disparity information corresponding to the certain number of pieces of superimposition information that are to be displayed on the same screen are inserted into the second data stream, and all the certain number of pieces of individual disparity information are arranged before the pieces of data of the certain number of pieces of superimposition information. Also, for example, a certain number of pieces of individual disparity information corresponding to the certain number of pieces of superimposition information that are to be displayed on the same screen are inserted into the second data stream, and each of the certain number of pieces of individual disparity information is arranged before the piece of data of the corresponding piece of the superimposition information. Also, for example, common disparity information corresponding to the certain number of pieces of superimposition information that are to be displayed on the same screen is inserted into the second data stream, and the common disparity information is arranged before the pieces of data of the certain number of pieces of superimposition information.

As described above, in this embodiment of the present disclosure, disparity information is inserted as management information of a certain number of pieces of superimposition information into the second data stream, so that pieces of data of the respective pieces of superimposition information are associated with the disparity information. On the receiver side, an appropriate disparity can be given by using pieces of disparity information corresponding to the certain number of pieces of superimposition information that are to be superimposed on a left-eye image and a right-eye image. Accordingly, the perspective consistency with individual objects in an image can be maintained in the optimum state in display of superimposition information, such as captions.

According to another embodiment of the present disclosure, there is provided a stereo image data receiving apparatus including: a data receiving unit configured to receive a multiplexed data stream including a first data stream and a second data stream, the first data stream including stereo image data including left-eye image data and right-eye image data for displaying a stereo image, the second data stream including data of superimposition information that is to be superimposed on images based on the left-eye image data and the right-eye image data and disparity information for giving disparity by shifting the superimposition information that is to be superimposed on the images based on the left-eye image data and the right-eye image data, pieces of data of a certain number of pieces of superimposition information that are to be displayed on the same screen being sequentially arranged in the second data stream, the disparity information being inserted as management information of the certain number of pieces of superimposition information into the second data stream; an image data obtaining unit configured to obtain the stereo image data from the first data stream included in the multiplexed data stream received by the data receiving unit; a superimposition information data obtaining unit configured to obtain the data of the superimposition information from the second data stream included in the multiplexed data stream received by the data receiving unit; a disparity information obtaining unit configured to obtain the disparity information from the second data stream included in the multiplexed data stream received by the data receiving unit; and an image data processing unit configured to give disparity to the same superimposition information that is to be superimposed on a left-eye image and a right-eye image using the left-eye image data and the right-eye image data included in the stereo image data obtained by the image data obtaining unit, the disparity information obtained by the disparity information obtaining unit, and the data of the superimposition information obtained by the superimposition information data obtaining unit, thereby obtaining data of the left-eye image on which the superimposition information is superimposed and data of the right-eye image on which the superimposition information is superimposed.

In this embodiment of the present disclosure, the data receiving unit receives a multiplexed data stream including a first data stream and a second data stream. The first data stream includes stereo image data including left-eye image data and right-eye image data for displaying a stereo image. Also, the second data stream includes data of superimposition information that is to be superimposed on images based on the left-eye image data and the right-eye image data, and disparity information for giving disparity by shifting the superimposition information that is to be superimposed on the images based on the left-eye image data and the right-eye image data.

In the second data stream, pieces of data of a certain number of pieces of superimposition information that are to be displayed on the same screen are sequentially arranged. In the second data stream, disparity information is inserted as management information of the certain number of pieces of superimposition information. For example, the data of superimposition information is caption sentence data based on the ARIB method, and the disparity information is inserted as caption management data into the second data stream.

The image data obtaining unit obtains stereo image data from the first data stream included in the multiplexed data stream received by the data receiving unit. Also, the superimposition information data obtaining unit obtains the data of superimposition information from the second data stream included in the multiplexed data stream received by the data receiving unit. Also, the disparity information obtaining unit obtains disparity information from the second data stream included in the multiplexed data stream received by the data receiving unit.

The image data processing unit gives disparity to the same superimposition information that is to be superimposed on a left-eye image and a right-eye image by using the left-eye image data, right-eye image data, the data of superimposition information, and disparity information, thereby obtaining data of the left-eye image on which the superimposition information is superimposed and data of the right-eye image on which the superimposition information is superimposed.

As described above, in this embodiment of the present disclosure, disparity information is inserted as management information of a certain number of pieces of superimposition information into the second data stream, so that the pieces of data of the respective pieces of superimposition information are associated with the disparity information. Accordingly, the image data processing unit can give an appropriate disparity by using the disparity information corresponding to the certain number of pieces of superimposition information that are to be superimposed on a left-eye image and a right-eye image. Therefore, the perspective consistency with individual objects in an image can be maintained in the optimum state in display of superimposition information.

According to the embodiments of the present disclosure, a multiplexed data stream including a first data stream, which includes stereo image data, and a second data stream, which includes the data of superimposition information and disparity information, is transmitted from a transmitter side to a receiver side. In the second data stream, piece of data of a certain number of pieces of superimposition information that are to be displayed on the same screen are sequentially arranged. Also, disparity information is inserted as management information of the certain number of pieces of superimposition information into the second data stream, so that the pieces of data of the respective pieces of superimposition information are associated with the disparity information.

Therefore, on the receiver side, an appropriate disparity can be given by using the disparity information corresponding to the certain number of pieces of superimposition information that are to be superimposed on a left-eye image and a right-eye image. Accordingly, the perspective consistency with individual objects in an image can be maintained in the optimum state in display of superimposition information, such as captions.

### BRIEF DESCRIPTION OF THE DRAWINGS

FIG. 1 is a block diagram illustrating an example configuration of a stereo image display system as an embodiment of the present disclosure;

FIG. 2 is a block diagram illustrating an example configuration of a transmission data generating unit in a broadcast station;

FIG. 3 is a diagram illustrating image data of a pixel format of 1920×1080 pixels;

FIGS. 4A to 4C are diagrams describing a “Top & Bottom” method, a “Side By Side” method, and a “Frame Sequential” method, which are methods for transmitting stereo image data (3D image data);

FIG. 5 is a diagram describing an example of detecting disparity vectors of a right-eye image with respect to a left-eye image;

FIG. 6 is a diagram describing obtaining a disparity vector using a block matching method;

FIGS. 7A and 7B are diagrams illustrating an example configuration of a caption data stream and an example display of caption units (captions);

FIG. 8 is a diagram illustrating an example image in a case where the values of disparity vectors of respective pixels are used as luminance values of the respective pixels;

FIG. 9 is a diagram illustrating an example of disparity vectors of respective blocks;

FIGS. 10A to 10D are diagrams describing a downsizing process that is performed by a disparity information creating unit of a transmission data generating unit;

FIGS. 11A to 11D are diagrams illustrating an example configuration of a caption data stream generated by a caption encoder and an example of creating disparity vectors in that case;

FIGS. 12A to 12D are diagrams illustrating another example configuration of a caption data stream generated by the caption encoder and an example of creating disparity vectors in that case;

FIGS. 13A to 13D are diagrams illustrating another example configuration of a caption data stream generated by the caption encoder and an example of creating a disparity vector in that case;

FIGS. 14A and 14B are diagrams describing the case of shifting the positions of respective caption units superimposed on first and second views;

FIG. 15 is a diagram describing the packet structure of caption codes included in a caption sentence data group;

FIG. 16 is a diagram describing the packet structure of control codes included in a caption management data group;

FIG. 17 is a diagram illustrating the function and content of a control code “ZDP” added to an expansion control code relating to ARIB character control;

FIG. 18 is a diagram illustrating a control code set code table (only a main part is illustrated);

FIGS. 19A and 19B are diagrams illustrating an example display of a caption (graphics information) on an image and the perspective of a background, a foreground object, and the caption;

FIGS. 20A to 20C are diagrams illustrating an example display of a caption on an image, and a left-eye caption LGI and a right-eye caption RGI for displaying a caption;

FIG. 21 is a block diagram illustrating an example configuration of a set top box forming the stereo image display system;

FIG. 22 is a block diagram illustrating an example configuration of a bit stream processing unit forming the set top box;

FIG. 23 is a block diagram illustrating an example configuration of a television receiver forming the stereo image display system;

FIG. 24 is a block diagram illustrating another example configuration of the stereo image display system; and

FIG. 25 is a diagram describing a relationship between the display positions of left and right images of an object on a screen and the reproduction position of the stereo image thereof in stereo image display using binocular disparity.

### DETAILED DESCRIPTION OF EMBODIMENTS

Hereinafter, an embodiment of the present disclosure will be described. The description will be given in the following order.
1. Embodiment
2. Modification

### 1. Embodiment

### Example Configuration of Stereo Image Display System

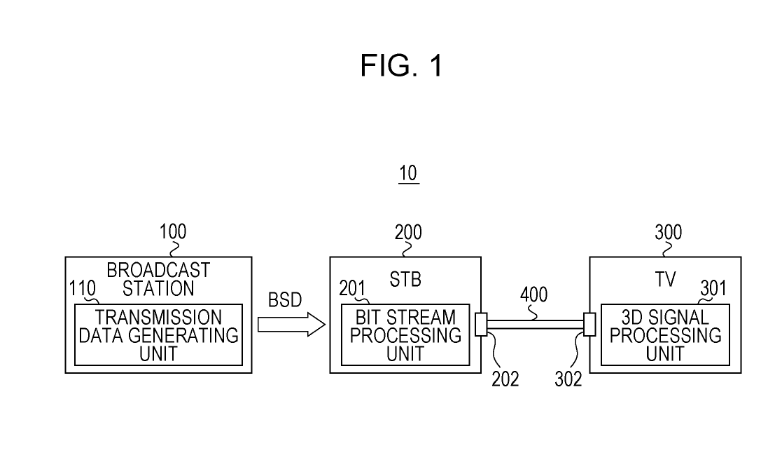

FIG. 1 illustrates an example configuration of a stereo image display system 10 according to the embodiment. The stereo image display system 10 includes a broadcast station 100, a set top box (STB) 200, and a television receiver 300.

The set top box 200 and the television receiver 300 are connected to each other via a high definition multimedia interface (HDMI) cable 400. The set top box 200 is provided with an HDMI terminal 202. The television receiver 300 is provided with an HDMI terminal 302. One end of the HDMI cable 400 is connected to the HDMI terminal 202 of the set top box 200, and the other end of the HDMI cable 400 is connected to the HDMI terminal 302 of the television receiver 300.

### Description of Broadcast Station

The broadcast station 100 transmits bit stream data BSD using airwaves. The broadcast station 100 includes a transmission data generating unit 110 that generates bit stream data BSD. The bit stream data BSD includes stereo image data including left-eye image data and right-eye image data, audio data, data of superimposition information, and furthermore disparity information (disparity vectors), etc. The superimposition information may be graphics information, text information, or the like. In this embodiment, the superimposition information includes captions.

### Example Configuration of Transmission Data Generating Unit

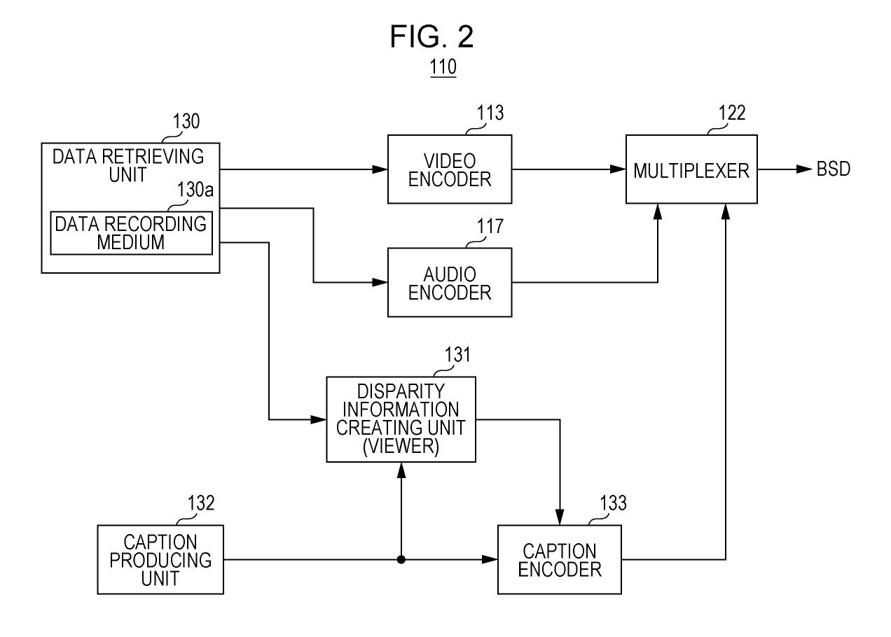

FIG. 2 illustrates an example configuration of the transmission data generating unit 110 in the broadcast station 100. The transmission data generating unit 110 transmits disparity information (disparity vectors) with a data structure that can be easily compatible with Association of Radio Industries and Businesses (ARIB), which is one of existing broadcasting standards. The transmission data generating unit 110 includes a data retrieving unit (archive unit) 130, a disparity information creating unit 131, a video encoder 113, an audio encoder 117, a caption producing unit 132, a caption encoder 133, and a multiplexer 122.

A data recording medium 130a is loaded to the data retrieving unit 130 in a removable manner, for example. Audio data and disparity information are recorded in association with each other on the data recording medium 130a, together with stereo image data including left-eye image data and right-eye image data. The data retrieving unit 130 retrieves stereo image data, audio data, disparity information, etc., from the data recording medium 130a, and outputs them. The data recording medium 130a is a disc-shaped recording medium, a semiconductor memory, or the like.

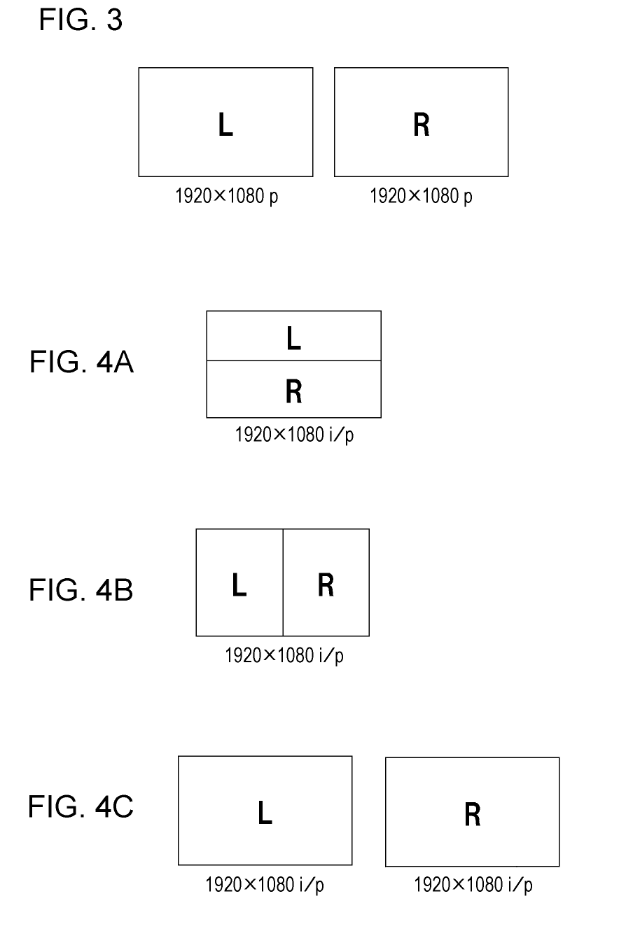

The stereo image data recorded on the data recording medium 130a is stereo image data based on a certain transmission method. An example of a method for transmitting stereo image data (3D image data) will be described. Here, the following first to third methods are suggested, but another transmission method may be used instead. Also, a description will be given here of a case where each of image data of a left eye (L) and image data of a right eye (R) is image data of a determined resolution, for example, of a pixel format of 1920×1080 pixels, as illustrated in FIG. 3.

The first transmission method is a “Top & Bottom” method, that is, a method for transmitting data of each line of left-eye image data from a first half in the vertical direction, and transmitting data of each line of left-eye image data from a latter half in the vertical direction, as illustrated in FIG. 4A. In this case, the lines of the left-eye image data and right-eye image data are thinned to one half, so that the vertical resolution is reduced to half that of the original signal.

The second transmission method is a “Side By Side” method, that is, a method for transmitting pixel data of left-eye image data from a first half in the horizontal direction, and transmitting pixel data of right-eye image data from a latter half in the horizontal direction, as illustrated in FIG. 4B. In this case, in each of the left-eye image data and right-eye image data, the pixel data in the horizontal direction is thinned to one half. The horizontal resolution is reduced to half that of the original signal.

The third transmission method is a “Frame Sequential” method or a 2D backward compatibility method, that is, a method for transmitting left-eye image data and right-eye image data by sequentially switching therebetween for each frame, as illustrated in FIG. 4C.

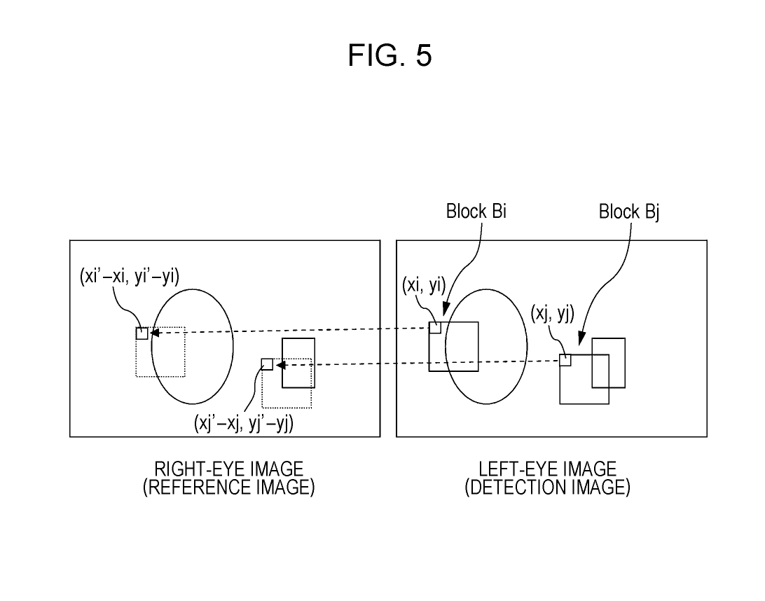

The disparity information recorded on the data recording medium 130a includes disparity vectors of respective pixels forming an image, for example. An example of detecting disparity vectors will be described. Here, an example of detecting disparity vectors of a right-eye image with respect to a left-eye image will be described. As illustrated in FIG. 5, the left-eye image is regarded as a detection image, and the right-eye image is regarded as a reference image. In this example, the disparity vectors at the positions (xi, yi) and (xj, yj) are detected.

The case of detecting a disparity vector at the position (xi, yi) will be described as an example. In this case, a pixel block (disparity detection block) Bi of 8×8 or 16×16, for example, with the pixel at the position (xi, yi) being at the top-left, is set in the left-eye image. Then, a pixel block that matches the pixel block Bi is searched for in the right-eye image.

In this case, a search range having the position (xi, yi) at the center is set in the right-eye image, and comparison blocks of 8×8 or 16×16, for example, similar to the above-described pixel block Bi, are sequentially set by sequentially regarding the individual pixels in the search range as a target pixel.

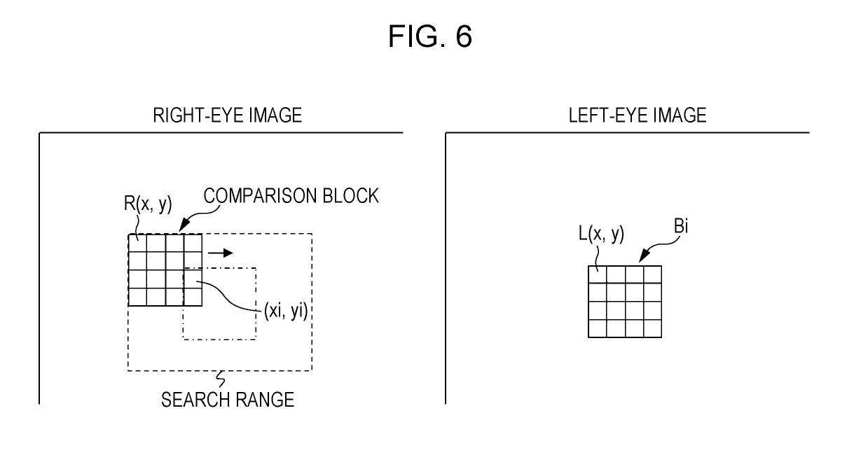

The sums of absolute values of differences between pixels corresponding to each other are obtained between the pixel block Bi and the comparison blocks that are sequentially set. Here, as illustrated in FIG. 6, when the pixel value of the pixel block Bi is L(x, y) and the pixel value of the comparison block is R(x, y), the sum of absolute values of differences between the pixel block Bi and a certain comparison block is expressed by Σ|L(x, y)−R(x, y)|.

When n pixels are included in the search range that is set in the right-eye image, n sums S1 to Sn are eventually obtained, and a minimum sum 5 min is selected from among them. Then, the position (xi′, yi′) of the pixel at the top-left is obtained from the comparison block from which the sum 5 min is obtained. Accordingly, the disparity vector at the position (xi, yi) is detected as (xi′-xi, yi′-yi). Although a detailed description is omitted, the disparity vector at the position (xj, yj) is also detected in a similar process procedure, with a pixel block Bj of 8×8 or 16×16, for example, being set with the pixel at the position (xj, yj) being at the top-left in the left-eye image.

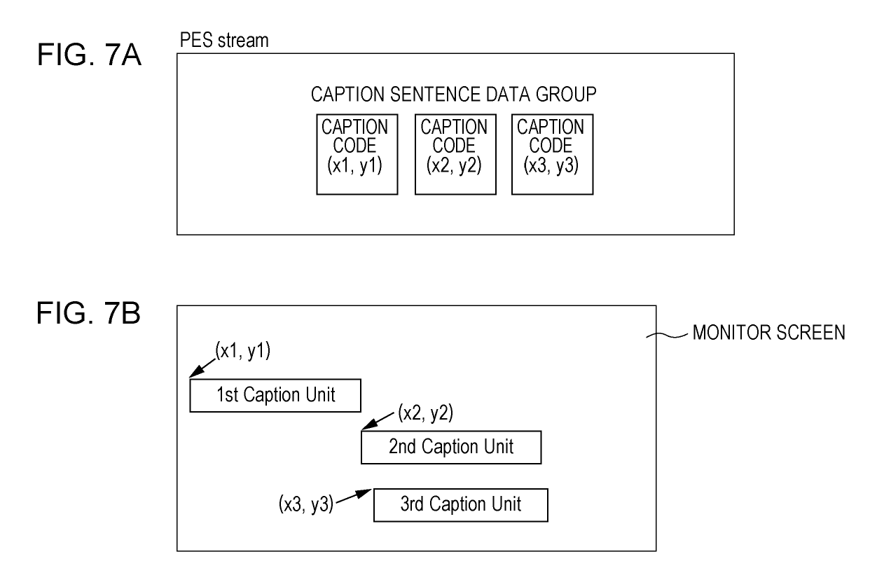

Referring back to FIG. 2, the caption producing unit 132 produces caption data (caption sentence data based on the ARIB method). The caption encoder 133 generates a caption data stream (caption elementary stream) including the caption data produced by the caption producing unit 132. FIG. 7A illustrates an example configuration of the caption data stream. This example shows, as illustrated in FIG. 7B, an example in which three caption units (captions) “1st Caption Unit”, “2nd Caption Unit”, and “3rd Caption Unit” are displayed on the same screen.

The pieces of caption data of the respective caption units are inserted as pieces of caption sentence data (caption codes) of a caption sentence data group into the caption data stream. The setting data about a display area of each caption unit or the like is inserted as the data of a caption management data group into the caption data stream, although not illustrated. The display areas of the caption units “1st Caption Unit”, “2nd Caption Unit”, and “3rd Caption Unit” are represented by (x1, y1), (x2, y2), and (x3, y3), respectively.

The disparity information creating unit 131 has a viewer function. The disparity information creating unit 131 performs a downsizing process on the disparity vectors output from the data retrieving unit 130, that is, the disparity vectors of respective pixels, thereby generating a disparity vector belonging to a certain area.

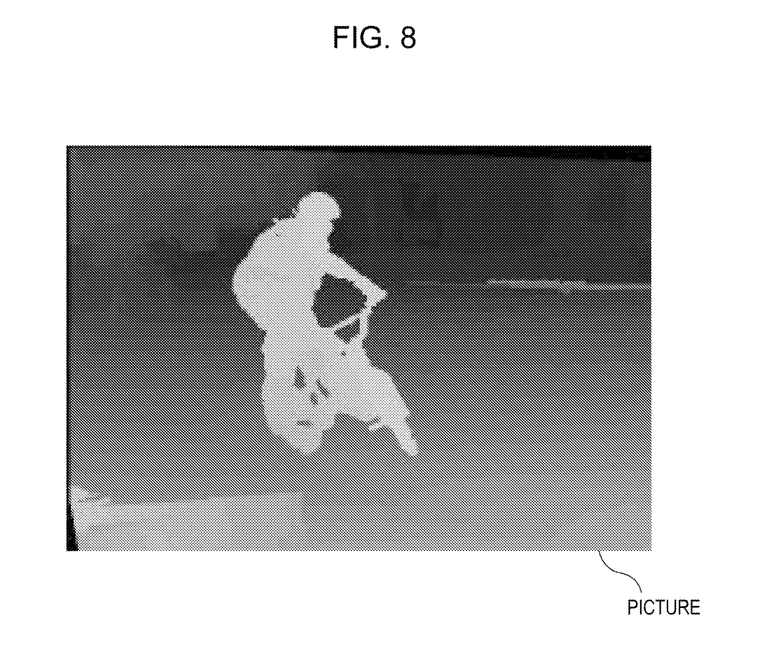

FIG. 8 illustrates an example of data in a relative depth direction that is given as the luminance values of respective pixels. Here, the data in the relative depth direction can be handled as disparity vectors of respective pixels by using certain conversion. In this example, the luminance value is large in the portion of the person. This means that the value of a disparity vector is large in the portion of the person, and thus means that the portion of the person is perceived as being popped up in stereo image display. Also, in this example, the luminance value is small in the portion of the background. This means that the value of a disparity vector is small in the portion of the background, and thus means that the portion of the background is perceived as being on the back side in stereo image display.

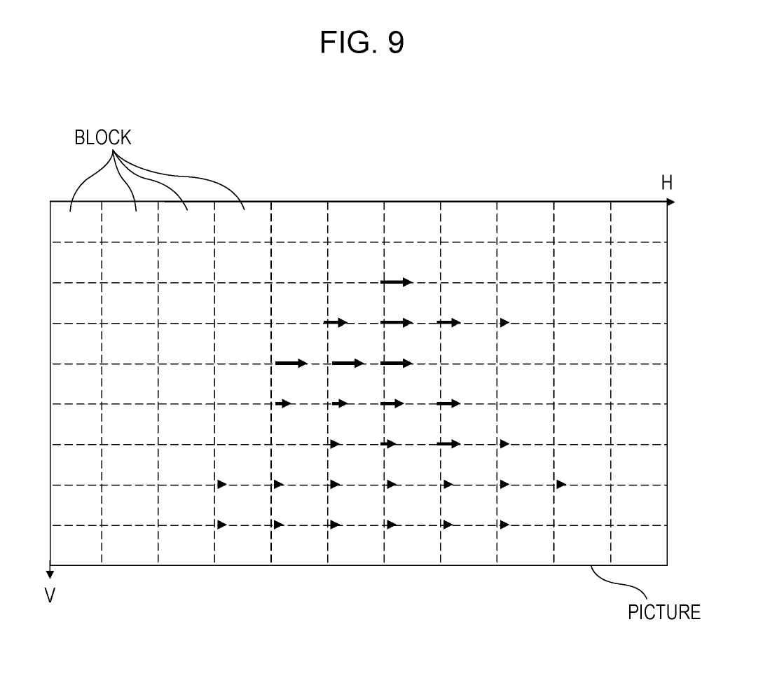

FIG. 9 illustrates an example of disparity vectors of respective blocks. The blocks are in the upper layer of pixels positioned in the bottom layer. These blocks are formed by dividing an image (picture) area into areas of a certain size in the horizontal direction and the vertical direction. The disparity vector of each block is obtained by selecting the disparity vector of the largest value from among the disparity vectors of all the pixels existing in the block, for example. In this example, the disparity vector of each block is represented by an arrow, and the length of the arrow corresponds to the size of the disparity vector.

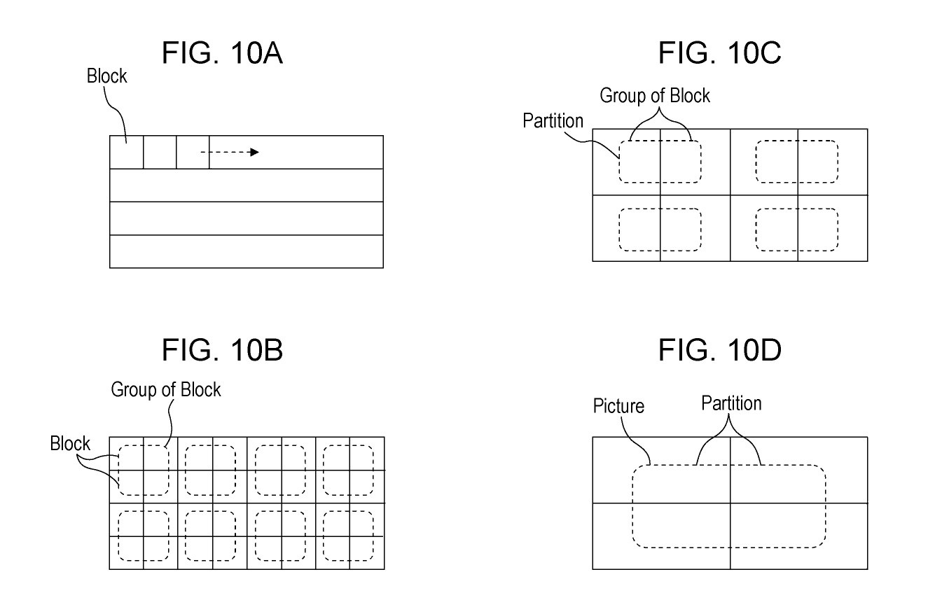

FIGS. 10A to 10D illustrate an example of a downsizing process that is performed in the disparity information creating unit 131. First, the disparity information creating unit 131 obtains the disparity vectors of the respective blocks using the disparity vectors of the respective pixels, as illustrated in FIG. 10A. As described above, the blocks are in the upper layer of pixels positioned in the bottom layer and are formed by dividing an image (picture) area into areas of a certain size in the horizontal direction and the vertical direction. Also, the disparity vector of each block is obtained by selecting the disparity vector of the largest value from among the disparity vectors of all the pixels existing in the block, for example.

Next, the disparity information creating unit 131 obtains the disparity vectors of respective groups (Groups Of Blocks) using the disparity vectors of the respective blocks, as illustrated in FIG. 10B. The groups are in the upper layer of blocks and are obtained by grouping a plurality of blocks close to each other. In the example in FIG. 10B, each group is constituted by four blocks defined by a broken-line frame. Also, the disparity vector of each group is obtained by selecting the disparity vector of the largest value from among the disparity vectors of all the blocks existing in the group, for example.

Next, the disparity information creating unit 131 obtains the disparity vectors of respective partitions using the disparity vectors of the respective groups, as illustrated in FIG. 10C. The partitions are in the upper layer of groups and are obtained by grouping a plurality of groups close to each other. In the example in FIG. 10C, each partition is constituted by two groups defined by a broken-line frame. Also, the disparity vector of each partition is obtained by selecting the disparity vector of the largest value from among the disparity vectors of all the groups existing in the partition, for example.

Next, the disparity information creating unit 131 obtains the disparity vector of the entire picture (entire image) positioned in the top layer using the disparity vectors of the respective partitions, as illustrated in FIG. 10D. In the example in FIG. 10D, four partitions defined by a broken-line frame are included in the entire picture. Also, the disparity vector of the entire picture is obtained by selecting the disparity vector of the largest value from among the disparity vectors of all the partitions included in the entire picture, for example.

In this way, the disparity information creating unit 131 performs a downsizing process on the disparity vectors of the respective pixels positioned in the bottom layer, thereby being able to obtain the disparity vectors of the respective areas in the individual layers, that is, blocks, groups, partitions, and an entire picture. Note that, in the example of a downsizing process illustrated in FIGS. 10A to 10D, the disparity vectors in four layers, that is, blocks, groups, partitions, and an entire picture, are eventually obtained in addition to the layer of pixels. However, the number of layers, the method for dividing an area in each layer, and the number of areas are not limited thereto.

The disparity information creating unit 131 creates disparity vectors corresponding to a certain number of caption units (captions) that are to be displayed on the same screen through the above-described downsizing process. In this case, the disparity information creating unit 131 creates the disparity vectors of the respective caption units (individual disparity vectors) or creates a disparity vector common to the individual caption units (common disparity vector). The selection is performed depending on the setting made by a user, for example.

In the case of creating individual disparity vectors, the disparity information creating unit 131 obtains disparity vectors belonging to the display areas of the respective caption units on the basis of the display areas by performing the above-described downsizing process. Also, in the case of creating a common disparity vector, the disparity information creating unit 131 obtains the disparity vector of the entire picture (entire image) by performing the above-described downsizing process (see FIG. 10D). In the case of creating a common disparity vector, the disparity information creating unit 131 may obtain the disparity vectors belonging to the display areas of the respective caption units and select the disparity vector of the largest value.

The caption encoder 133 causes the disparity vectors created by the disparity information creating unit 131 in the above-described manner to be included in a caption data stream. In this case, the pieces of caption data of the respective caption units that are to be displayed on the same screen are inserted as pieces of caption sentence data (caption codes) of a caption sentence data group into a caption data stream. Also, the values of the disparity vectors are inserted as pieces of caption management data (control codes) of a caption management data group into this caption data stream.

Now, a description will be given of a case where individual disparity vectors are created by the disparity information creating unit 131. Here, assume that three caption units (captions) “1st Caption Unit”, “2nd Caption Unit”, and “3rd Caption unit” are displayed on the same screen.

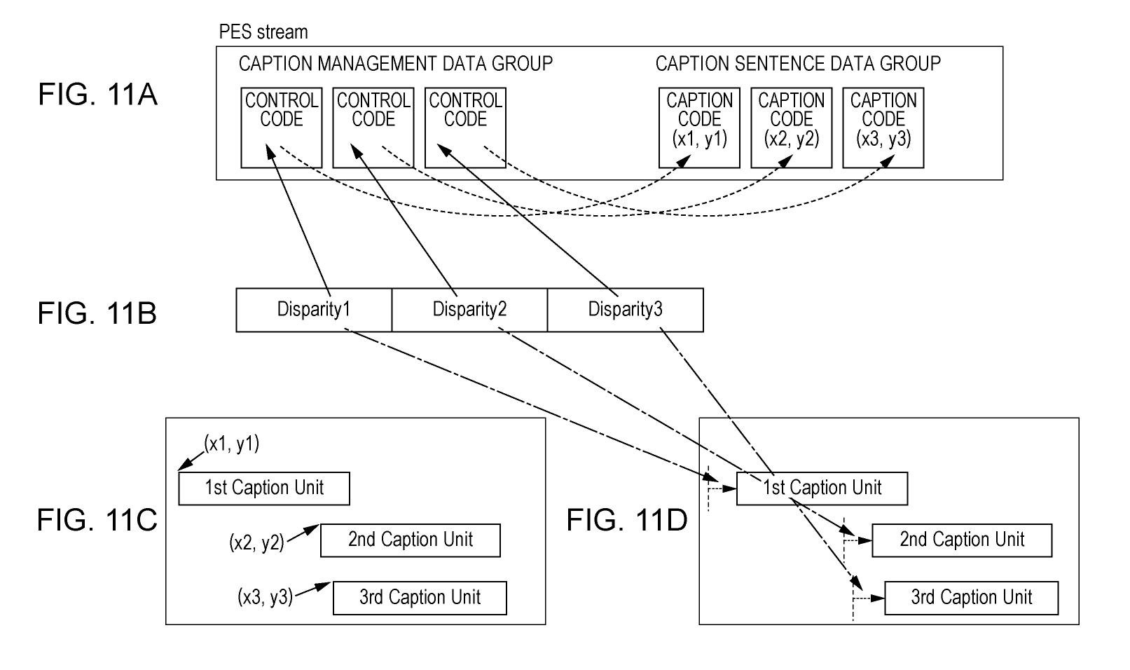

The disparity information creating unit 131 creates individual disparity vectors corresponding to the respective caption units, as illustrated in FIG. 11B. “Disparity 1” is an individual disparity vector corresponding to “1st Caption Unit”. “Disparity 2” is a disparity vector corresponding to “2nd Caption Unit”. “Disparity 3” is an individual disparity vector corresponding to “3rd Caption Unit”.

FIG. 11A illustrates an example configuration of a caption data stream generated by the caption encoder 133. The pieces of caption data of the respective caption units are inserted as pieces of caption sentence data (caption codes) of a caption sentence data group into this caption data stream. The setting data about the display areas of the respective caption units is inserted as pieces of caption management data (control codes) of a caption management data group into the caption data stream, although not illustrated. The display areas of the caption units “1st Caption Unit”, “2nd Caption Unit”, and “3rd Caption unit” are represented by (x1, y1), (x2, y2) and (x3, y3), respectively.

Also, the values of the individual disparity vectors of the respective caption units are inserted as pieces of caption management data (control codes) of the caption management data group into this caption data stream. In this way, the values of the individual disparity vectors of the respective caption units are inserted as pieces of caption management data (control codes) into the caption data stream, so that the pieces of caption data of the respective caption units are associated with the individual disparity vectors of the respective caption units.

FIG. 11C illustrates a first view (1st View) in which the individual caption units (captions) are superimposed, for example, a right-eye image. Also, FIG. 11D illustrates a second view (2nd View) in which the individual caption units are superimposed, for example, a left-eye image. The individual disparity vectors corresponding to the respective caption units are used for giving disparities between the individual caption units superimposed on the right-eye image and the individual caption units superimposed on the left-eye image, as illustrated.

In the example configuration illustrated in FIG. 11A, one caption sentence data group includes the pieces of caption sentence data (caption codes) of the caption units “1st Caption Unit”, “2nd Caption Unit”, and “3rd Caption unit”. Also, one caption management data group arranged before the one caption sentence data group includes pieces of caption management data (control codes) having the individual disparity vectors of the respective caption units.

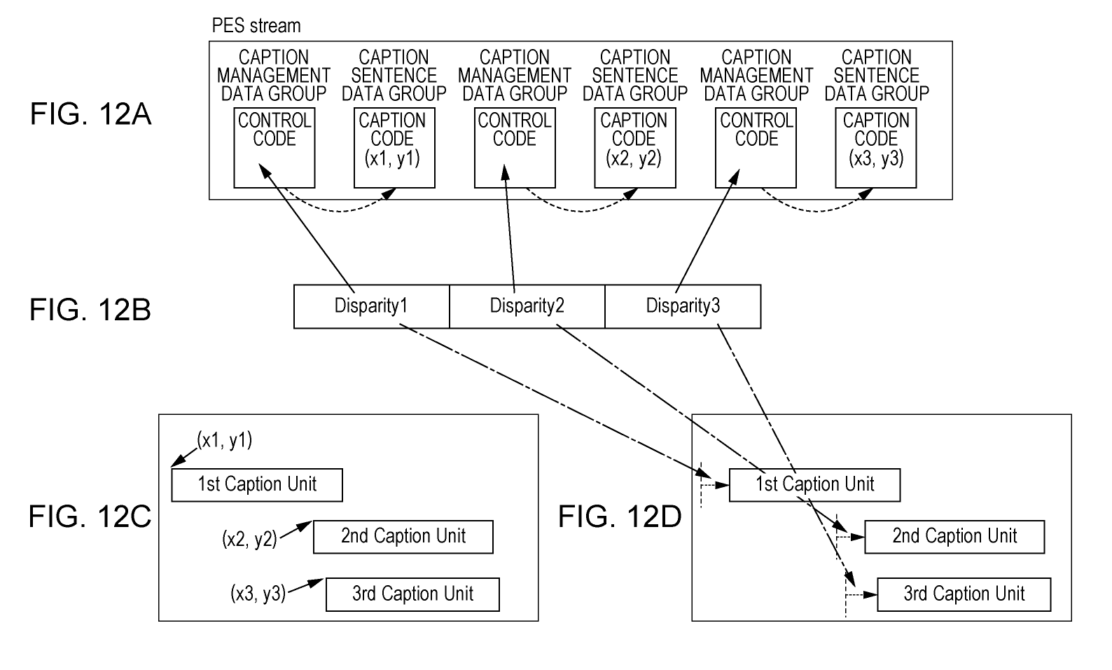

However, the example configuration of the caption data stream illustrated in FIG. 12A is also accepted. In this example configuration, the pieces of caption sentence data (caption codes) of the caption units “1st Caption Unit”, “2nd Caption Unit”, and “3rd Caption unit” are included in different caption sentence data groups. Also, the caption management data groups arranged before the respective caption sentence data groups include pieces of caption management data (control codes) having the individual disparity vectors of the respective caption units. FIGS. 12B, 12C, and 12D are the same as FIGS. 11B, 11C, and 11D.

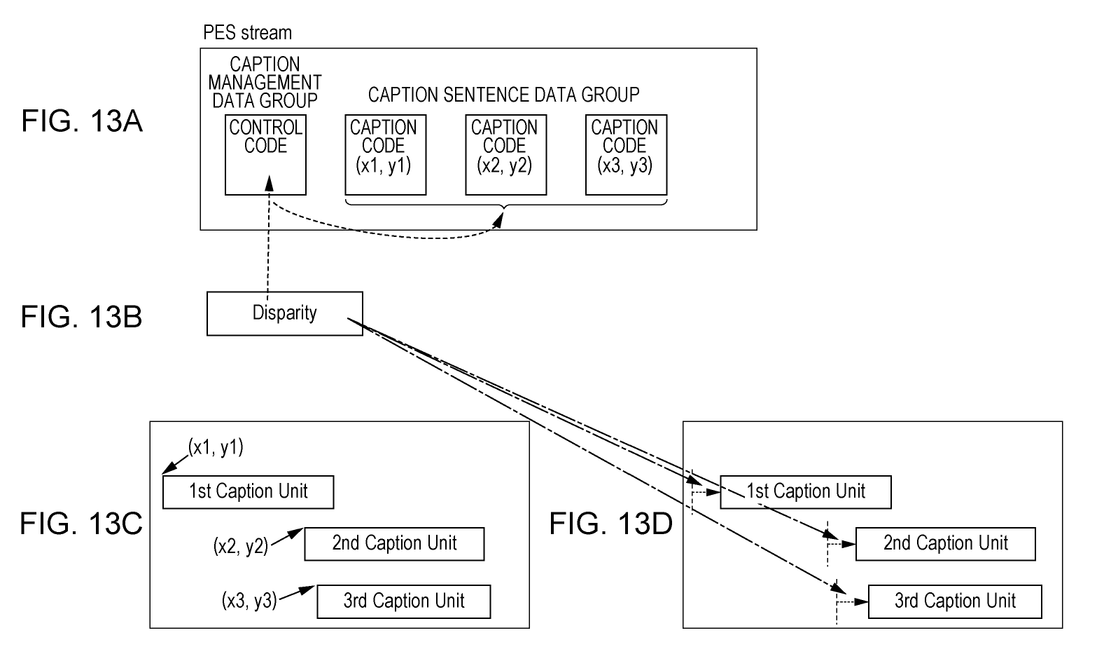

Next, a description will be given of a case where a common disparity vector is created by the disparity information creating unit 131. In this example, three caption units (captions) “1st Caption Unit”, “2nd Caption Unit”, and “3rd Caption unit” are displayed on the same screen. The disparity information creating unit 131 creates a common disparity vector “Disparity” common to the individual caption units, as illustrated in FIG. 13B.

FIG. 13A illustrates an example configuration of a caption data stream generated by the caption encoder 133. The pieces of caption data of the respective caption units are inserted as pieces of caption sentence data (caption codes) of a caption sentence data group into this caption data stream. The setting data about the display areas of the respective caption units is inserted as caption management data (control code) of a caption management data group into the caption data stream, although not illustrated. The display areas of the caption units “1st Caption Unit”, “2nd Caption Unit”, and “3rd Caption unit” are represented by (x1, y1), (x2, y2) and (x3, y3), respectively.

Also, the value of a common disparity vector common to the individual caption units is inserted as the caption management data (control code) of the caption management data group into this caption data stream. In this way, the value of the common disparity vector is inserted as the caption management data (control code) into the caption data stream, so that the pieces of caption data of the respective caption units are associated with the common disparity vector that is common to the individual caption units.

In the example configuration illustrated in FIG. 13A, the pieces of caption sentence data (caption codes) of the caption units “1st Caption Unit”, “2nd Caption Unit”, and “3rd Caption unit” are included in one caption sentence data group. Also, the caption management data (control code) having a common disparity vector common to the individual caption units is included in one caption management data group arranged before the one caption sentence data group.

FIG. 13C illustrates a first view (1st View) in which the individual caption units (captions) are superimposed, for example, a right-eye image. Also, FIG. 13D illustrates a second view (2nd View) in which the individual caption units are superimposed, for example, a left-eye image. The common disparity vector common to the individual caption units is used for giving a disparity between the individual caption units superimposed on the right-eye image and the individual caption units superimposed on the left-eye image, as illustrated.

In the examples illustrated in FIGS. 11C and 11D, FIGS. 12C and 12D, and FIGS. 13C and 13D, only the positions of the respective caption units superimposed on the second view (for example, a left-eye image) are shifted. However, a case where only the positions of the respective caption units superimposed on the first view (for example, a right-eye image) are shifted, or a case where the positions of the respective caption units superimposed on both views are shifted may be acceptable.

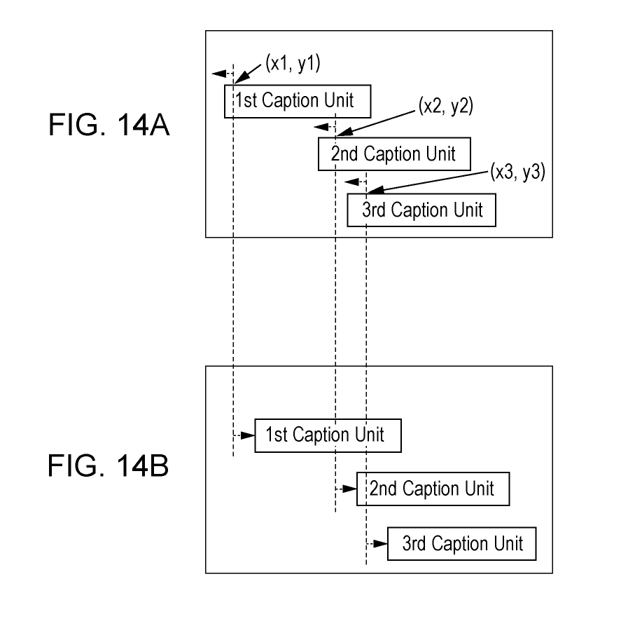

FIGS. 14A and 14B illustrate a case where the positions of the caption units superimposed on both the first and second views are shifted. In this case, the shift values (offset values) D[i] of the respective caption units in the first view and the second view are obtained in the following manner on the basis of the value “disparity[i]” of the disparity vectors “Disparity” corresponding to the respective caption units.

That is, in a case where disparity[i] is an even number, “D[i]=−disparity[i]/2” is obtained in the first view, and “D[i]=disparity[i]/2” is obtained in the second view. Accordingly, the positions of the respective caption units superimposed on the first view (for example, a right-eye image) are shifted to the left by “disparity[i]/2”, and the positions of the respective caption units superimposed on the second view (for example, a left-eye image) are shifted to the right by “disparity[i]/2”.

Also, in a case where disparity[i] is an odd number, “D[i]=−(disparity[i]+1)/2” is obtained in the first view, and “D[i]=(disparity[i]−1)/2” is obtained in the second view. Accordingly, the positions of the respective caption units superimposed on the first view (for example, a right-eye image) are shifted to the left by “(disparity[i]+1)/2”, and the positions of the respective caption units superimposed on the second view (for example, a left-eye image) are shifted to the right by “(disparity[i]−1)/2”.

### Packet Structures of Caption Codes and Control Codes

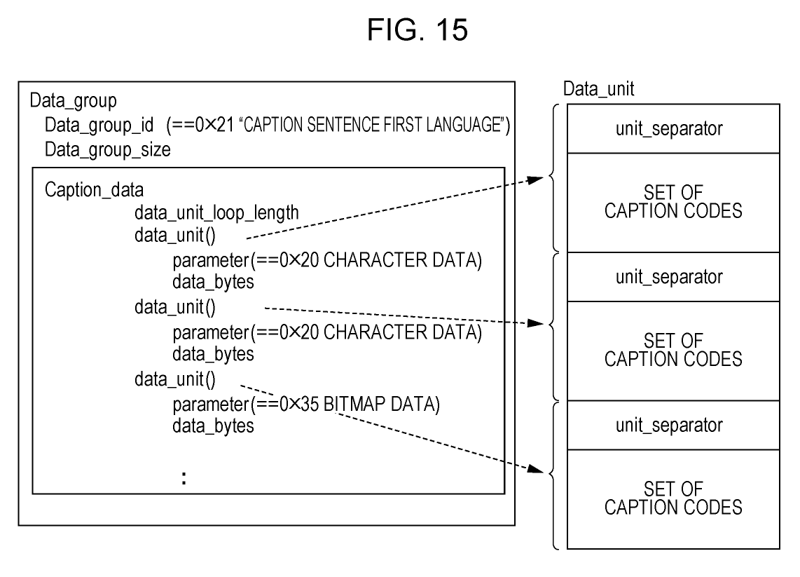

The packet structures of caption codes and control codes will be briefly described. First, the packet structure of caption codes will be described. FIG. 15 illustrates the packet structure of caption codes. “Data_group_id” represents data group identification. Here, it represents a caption sentence data group. “Data_group_id” representing a caption sentence data group further specifies a language. For example, “Data_group_id==0×21” represents a caption sentence data group and a caption sentence (first language).

“Data_group_size” represents the number of bytes of the subsequent data group data. In the case of a caption sentence data group, the data group data is caption sentence data (caption_data). In the caption sentence data, one or more data units are arranged. The individual data units are separated from each other by a data unit separation code (unit_separator). Caption codes are arranged as data unit data (data_unit_data) in each data unit.

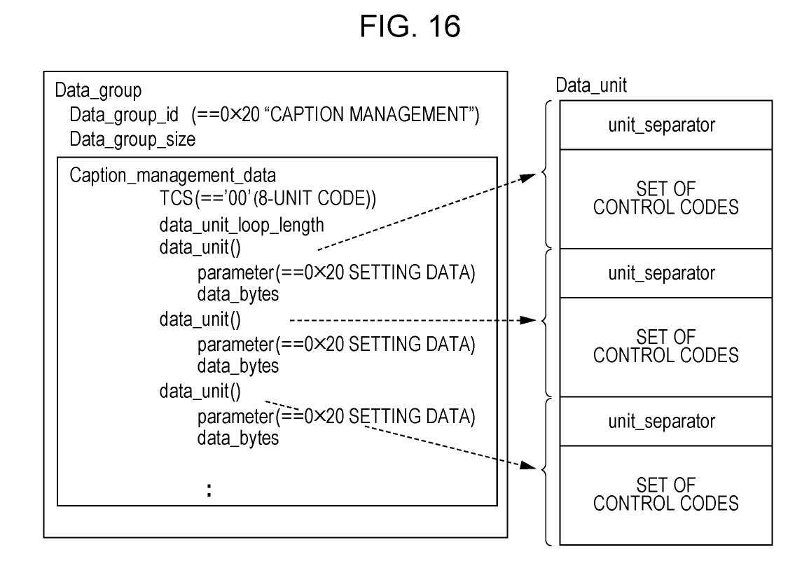

Next, the packet structure of control codes will be described. FIG. 16 illustrates the packet structure of control codes. “Data_group_id” represents data group identification. Here, it represents a caption management data group, and “Data_group_id==0×20” is obtained. “Data_group_size” represents the number of bytes of the subsequent data group data. In the case of a caption management data group, the data group data is caption management data (caption_management_data).

In the caption management data, one or more data units are arranged. The individual data units are separated from each other by a data unit separation code (unit_separator). Control codes are arranged as data unit data (data_unit_data) in each data unit. In this embodiment, the value of a disparity vector is given as an 8-unit code. “TCS” is data of two bits and represents a character coding method. Here, “TCS==00”, which represents an 8-unit code.

### 8-Unit Coding of Disparity Vector Value

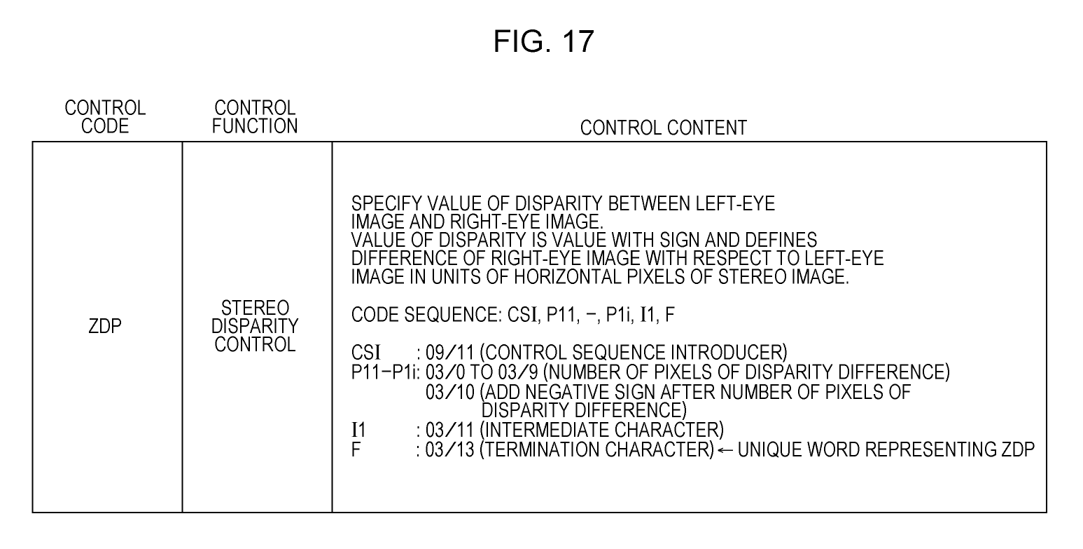

Now, 8-unit coding of a disparity vector value will be described. In order to give a disparity vector value as an 8-unit code, a control code “ZDP” is added to an expansion control code relating to ARIB character control. FIG. 17 illustrates the function and content of the control code “ZDP”.

The control code “ZDP” is a control code for controlling a stereo disparity and specifies the value of the disparity (disparity vector value) between a left-eye image and a right-eye image. This value of disparity is a value with a sign and defines the difference of a right-eye image with respect to a left-eye image in units of horizontal pixels of a stereo image.

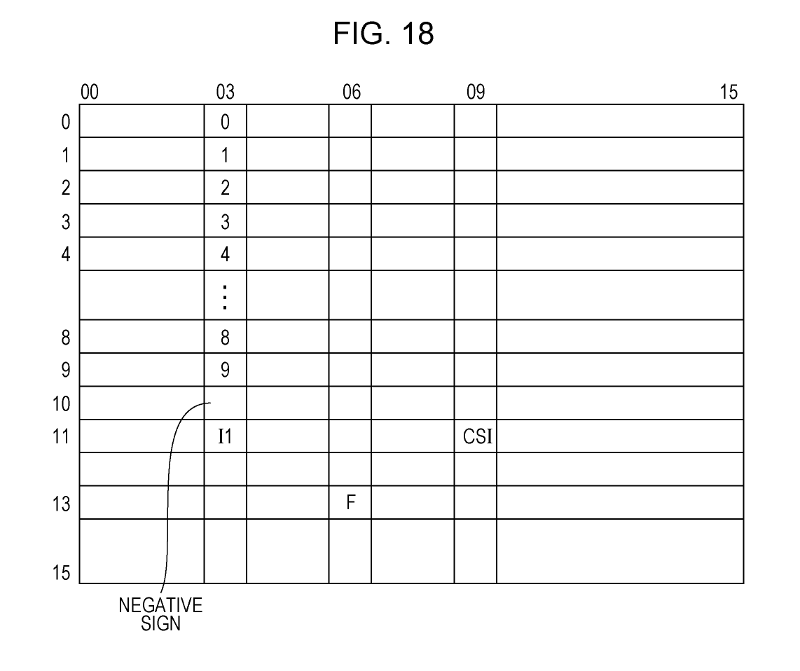

The code sequence of this control code “ZDP” is “CSI, P11, −, P1i, I1, F”. The individual codes will be described using the control code set code table (only a main part) illustrated in FIG. 18. The code “CSI” is a control sequence introducer for identifying an expansion control code. This code “CSI” is 8-bit data (b8-b1) made up of 4-bit data (b8b7b6b5) representing a column position (09) and 4-bit data (b4b3b2b1) representing a row position (11).

The parameter “P11-P1i” is a code of a column position (03) and represents the number of pixels of disparity difference. The code “P1i” is 8-bit data (b8-b1) made up of 4-bit data (b8b7b6b5) representing a column position (03) and 4-bit data (b4b3b2b1) representing a row position (i). When i=0 to 9, the code represents numbers “0” to “9”. For example, when the number of pixels of disparity difference is “2”, “P11-P1i” is “03/2”. Also, for example, when the number of pixels of disparity difference is “10”, “P11-P1i” is “03/1, 03/0”. Also, for example, when the number of pixels of disparity difference is “124”, “P11-P1i” is “03/1, 03/2, 03/4”.

When the above-described number of pixels of disparity difference is a negative number, a negative sign is added to the end of the parameter “P11-P1i”. This negative sign is, for example, 8-bit data (b8-b1) made up of 4-bit data (b8b7b6b5) representing a column position (03) and 4-bit data (b4b3b2b1) representing a row position (10). For example, when the number of pixels of disparity difference is “−2”, “P11-P1i” is “03/2, 03/10”.

The code “I1” is an intermediate character representing the end of the parameter “P11-P1i”. This code “I1” is 8-bit data (b8-b1) made up of 4-bit data (b8b7b6b5) representing a column position (03) and 4-bit data (b4b3b2b1) representing a row position (11). The code “F” is a termination character of the control code “ZDP”. This code “F” is a unique word representing the control code “ZDP”, and is 8-bit data (b8-b1) made up of 4-bit data (b8b7b6b5) representing a column position (06) and 4-bit data (b4b3b2b1) representing a row position (11), for example.

Referring back to FIG. 2, the video encoder 113 performs encoding on the stereo image data supplied from the data retrieving unit 130 in accordance with MPEG4-AVC, MPEG2, VC-1, or the like, thereby generating a video elementary stream. The audio encoder 117 performs encoding on the audio data supplied from the data retrieving unit 130 in accordance with MPEG-2 Audio AAC or the like, thereby generating an audio elementary stream.

The multiplexer 122 multiplexes the individual elementary streams output from the video encoder 113, the audio encoder 117, and the caption encoder 133. Then, the multiplexer 122 outputs bit stream data (transport stream) BSD serving as transmission data (multiplexed data stream).

The operation of the transmission data generating unit 110 illustrated in FIG. 2 will be briefly described. The stereo image data output from the data retrieving unit 130 is supplied to the video encoder 113. In the video encoder 113, encoding is performed on the stereo image data in accordance with MPEG4-AVC, MPEG2, VC-1, or the like, so that a video elementary stream including the encoded video data is generated. This video elementary stream is supplied to the multiplexer 122.

Also, in the caption producing unit 132, caption data based on the ARIB method is produced. The caption data is supplied to the caption encoder 133. In the caption encoder 133, a caption elementary stream (caption data stream) including the caption data produced by the caption producing unit 132 is generated. This caption elementary stream is supplied to the multiplexer 122.

Also, the disparity vectors of the respective pixels output from the data retrieving unit 130 are supplied to the disparity information creating unit 131. In the disparity information creating unit 131, disparity vectors (horizontal-direction disparity vectors) corresponding to a certain number of caption units (captions) to be displayed on the same screen are created through a downsizing process. In this case, in the disparity information creating unit 131, the disparity vectors of the respective caption units (individual disparity vectors) or a disparity vector common to all the caption units (common disparity vector) is created.

The disparity vectors created by the disparity information creating unit 131 are supplied to the caption encoder 133. In the caption encoder 133, the disparity vectors are caused to be included in a caption data stream (see FIGS. 11A to 13D). In this case, the pieces of caption data of the respective caption units to be displayed on the same screen are inserted as pieces of caption sentence data (caption codes) of a caption sentence data group into the caption data stream. Also, the values of the disparity vectors are inserted as pieces of caption management data (control codes) of a caption management data group into the caption data stream.

Also, the audio data output from the data retrieving unit 130 is supplied to the audio encoder 117. In the audio encoder 117, encoding is performed on the audio data in accordance with MPEG-2 Audio AAC or the like, so that an audio elementary stream including the encoded audio data is generated. This audio elementary stream is supplied to the multiplexer 122.

As described above, the multiplexer 122 is supplied with the elementary streams from the video encoder 113, the audio encoder 117, and the caption encoder 133. Then, in the multiplexer 122, the elementary streams supplied from the respective encoders are packetized and multiplexed, so that bit stream data (transport stream) BSD as transmission data is obtained.

In the transmission data generating unit 110 illustrated in FIG. 2, the bit stream data BSD output from the multiplexer 122 is a multiplexed data stream including a video data stream and a caption data stream. The video data stream includes stereo image data. Also, the caption data stream includes the data of captions (caption units) based on the ARIB method serving as superimposition information and disparity vectors (disparity information).

In the caption data stream, the pieces of caption data of a certain number of caption units to be displayed on the same screen are sequentially arranged. Also, disparity vectors (disparity information) are inserted as management information of the respective caption units into this caption data stream, so that the pieces of caption data of the respective caption units are associated with the disparity vectors.

Thus, on the receiver side (set top box 200), appropriate disparity can be given using corresponding disparity vectors (disparity information) to the certain number of caption units (captions) superimposed on a left-eye image and a right-eye image. Accordingly, the perspective consistency with individual objects in an image can be maintained in the optimum state in display of the caption units (captions).

### Description of Set Top Box

Referring back to FIG. 1, the set top box 200 receives bit stream data (transport stream) BSD that is transmitted using airwaves from the broadcast station 100. The bit stream data BSD includes stereo image data including left-eye image data and right-eye image data, and audio data. Also, the bit stream data BSD includes the pieces of caption data of caption units, and furthermore disparity vectors (disparity information) for giving disparity to the caption units.

The set top box 200 includes a bit stream processing unit 201. The bit stream processing unit 201 extracts stereo image data, audio data, the pieces of caption data of caption units, disparity vectors, etc., from the bit stream data BSD. The bit stream processing unit 201 generates the data of a left-eye image and a right-eye image on which captions are superimposed, using the stereo image data, the pieces of caption data of the caption units, etc.

In this case, the data of a left-eye caption and a right-eye caption to be superimposed on the left-eye image and the right-eye image are generated on the basis of a disparity vector and the caption data of a caption unit. Here, the left-eye caption and the right-eye caption are the same caption. However, the superimposition position in an image of the right-eye caption is shifted by the disparity vector in the horizontal direction with respect to the left-eye caption, for example. That is, a disparity is given between the left-eye caption and the right-eye caption, and the position at which the caption is recognized is in front of the image.

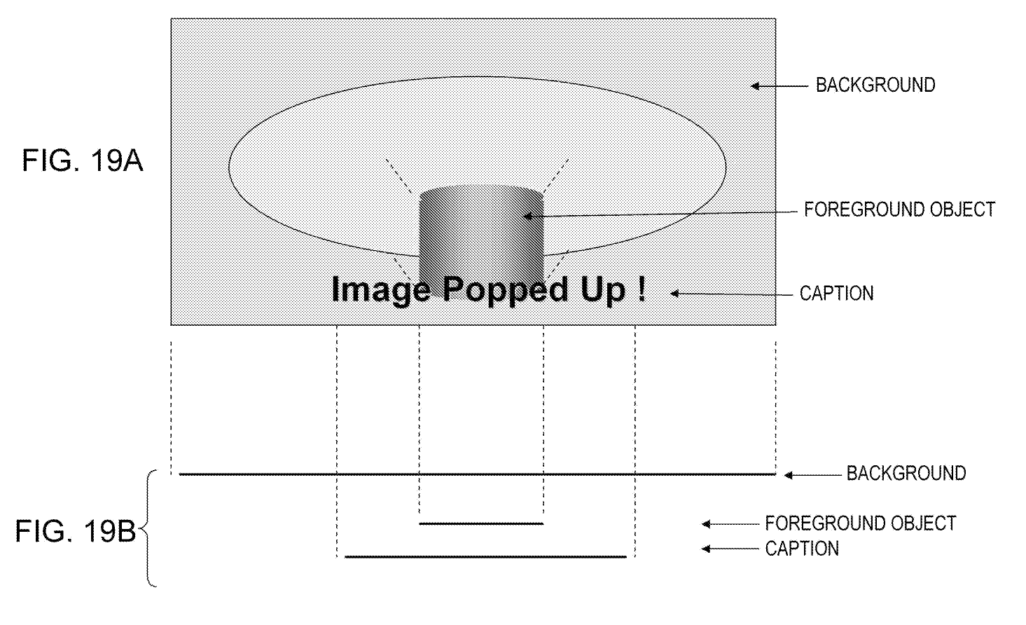

FIG. 19A illustrates an example display of a caption unit (caption) on an image. In this example display, a caption is superimposed on an image made up of a background and a foreground object. FIG. 19B illustrates the perspective of the background, foreground object, and caption, and illustrates that the caption is recognized as being the nearest.

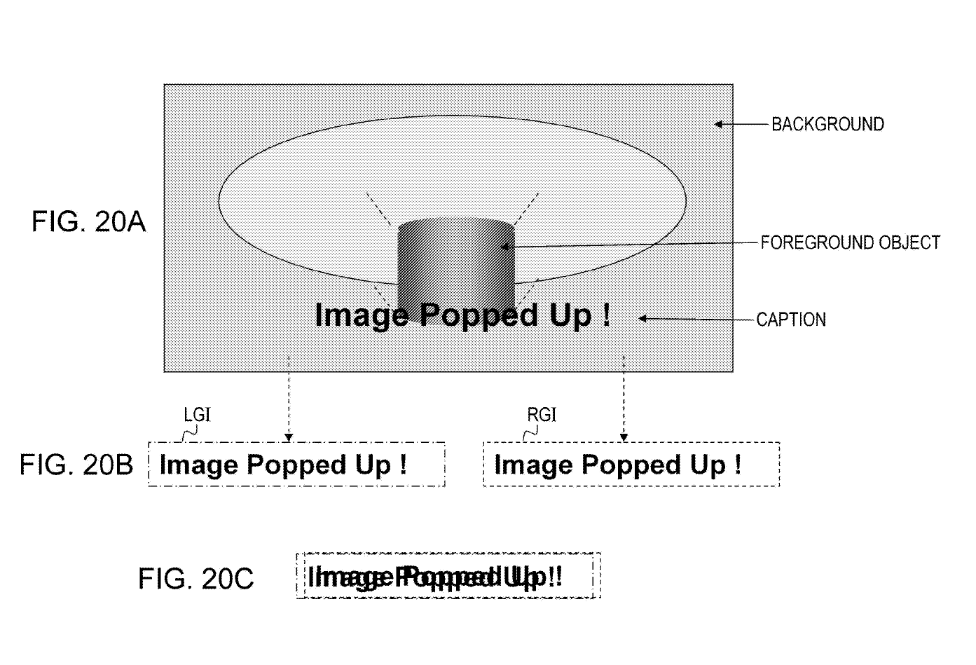

FIG. 20A illustrates an example display of a caption unit (caption) on an image, as in FIG. 19A. FIG. 20B illustrates a left-eye caption LGI superimposed on a left-eye image and a right-eye caption RGI superimposed on a right-eye image. FIG. 20C illustrates that a disparity is given between the left-eye caption LGI and the right-eye caption RGI so that the caption is recognized as being the nearest.

### Example Configuration of Set Top Box

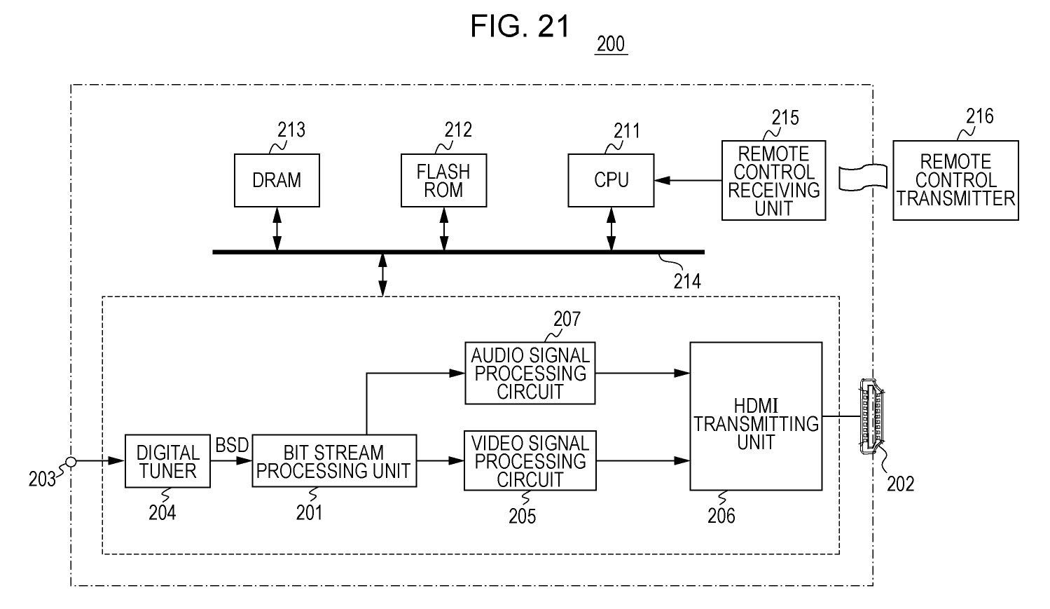

An example configuration of the set top box 200 will be described. FIG. 21 illustrates an example configuration of the set top box 200. The set top box 200 includes the bit stream processing unit 201, the HDMI terminal 202, an antenna terminal 203, a digital tuner 204, a video signal processing circuit 205, an HDMI transmitting unit 206, and an audio signal processing circuit 207. Also, the set top box 200 includes a central processing unit (CPU) 211, a flash read only memory (ROM) 212, a dynamic random access memory (DRAM) 213, an internal bus 214, a remote control receiving unit 215, and a remote control transmitter 216.

The antenna terminal 203 is a terminal for inputting a television broadcast signal that is received by a receiving antenna (not illustrated). The digital tuner 204 processes the television broadcast signal input to the antenna terminal 203, and outputs certain bit stream data (transport stream) BSD corresponding to a channel selected by a user.

The bit stream processing unit 201 extracts stereo image data, audio data, the pieces of caption data of caption units, disparity vectors, etc., from the bit stream data BSD, as described above. The bit stream processing unit 201 combines the data of a left-eye caption and a right-eye caption with the stereo image data, thereby generating stereo image data to be displayed and outputting the data. Also, the bit stream processing unit 201 outputs the audio data. The specific configuration of the bit stream processing unit 201 will be described below.

The video signal processing circuit 205 performs an image quality adjustment process or the like on the stereo image data output from the bit stream processing unit 201 as necessary, and supplies the processed stereo image data to the HDMI transmitting unit 206. The audio signal processing circuit 207 performs an audio quality adjustment process or the like on the audio data output from the bit stream processing circuit 201 as necessary, and supplies the processed audio data to the HDMI transmitting unit 206.

The HDMI transmitting unit 206 transmits the data of an image (video) and audio of the baseband from the HDMI terminal 202, through the communication compatible with HDMI. In this case, the data is transmitted using a transition minimized differential (TMDS) channel of HDMI, and thus the data of the image and audio is packed and is output from the HDMI transmitting unit 206 to the HDMI terminal 202.

The CPU 211 controls the operation of the individual units of the set top box 200. The flash ROM 212 stores control software and stores data. The DRAM 213 forms a work area of the CPU 211. The CPU 211 expands software and data read from the flash ROM 212 on the DRAM 213 and starts the software, and controls the individual units of the set top box 200.

The remote control receiving unit 215 receives a remote control signal (remote control code) transmitted from the remote control transmitter 216, and supplies it to the CPU 211. The CPU 211 controls the individual units of the set top box 200 on the basis of this remote control code. The CPU 211, the flash ROM 212, and the DRAM 213 are connected to the internal bus 214.

The operation of the set top box 200 will be briefly described. A television broadcast signal input to the antenna terminal 203 is supplied to the digital tuner 204. The digital tuner 204 processes the television broadcast signal, and outputs certain bit stream data (transport stream) BSD corresponding to a channel selected by a user.

The bit stream data BSD output from the digital tuner 204 is supplied to the bit stream processing unit 201. In the bit stream processing unit 201, stereo image data, audio data, the pieces of caption data of caption units, disparity vectors, etc. are extracted from the bit stream data BSD. Also, in the bit stream processing unit 201, the data of a left-eye caption and a right-eye caption is combined with the stereo image data, so that stereo image data to be displayed is generated.

The stereo image data to be displayed that is generated by the bit stream processing unit 201 is supplied to the video signal processing circuit 205. In the video signal processing circuit 205, an image quality adjustment process or the like is performed as necessary on the stereo image data to be displayed. The processed stereo image data to be displayed that is output from the video signal processing circuit 205 is supplied to the HDMI transmitting unit 206.

Also, the audio data obtained in the bit stream processing unit 201 is supplied to the audio signal processing circuit 207. In the audio signal processing circuit 207, an audio quality adjustment process or the like is performed as necessary on the audio data. The processed audio data that is output from the audio signal processing circuit 207 is supplied to the HDMI transmitting unit 206. Then, the stereo image data and audio data supplied to the HDMI transmitting unit 206 are transmitted from the HDMI terminal 202 to the HDMI cable 400 using a TMDS channel of HDMI.

### Example Configuration of Bit Stream Processing Unit

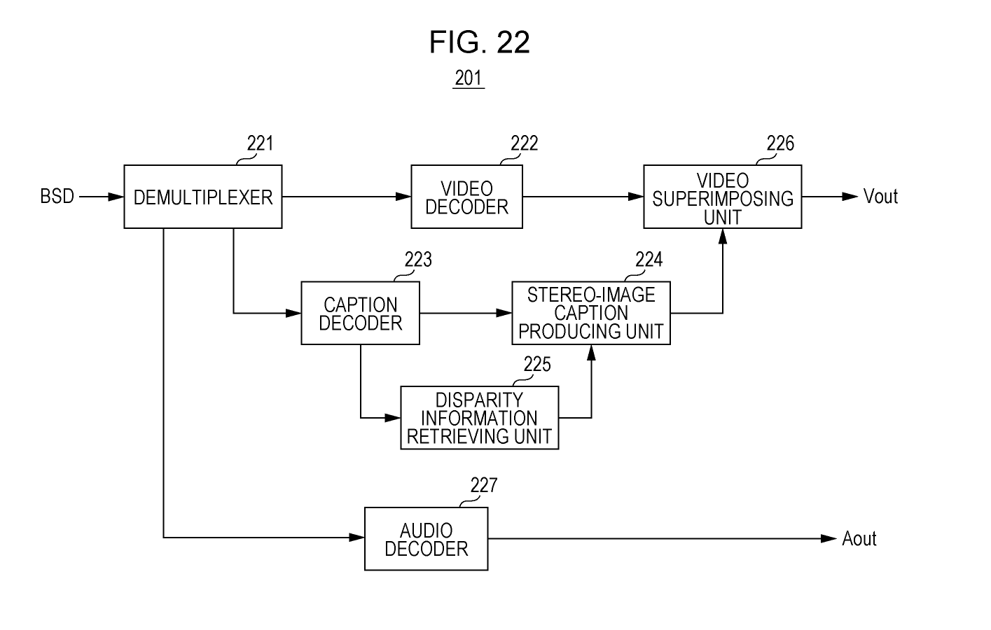

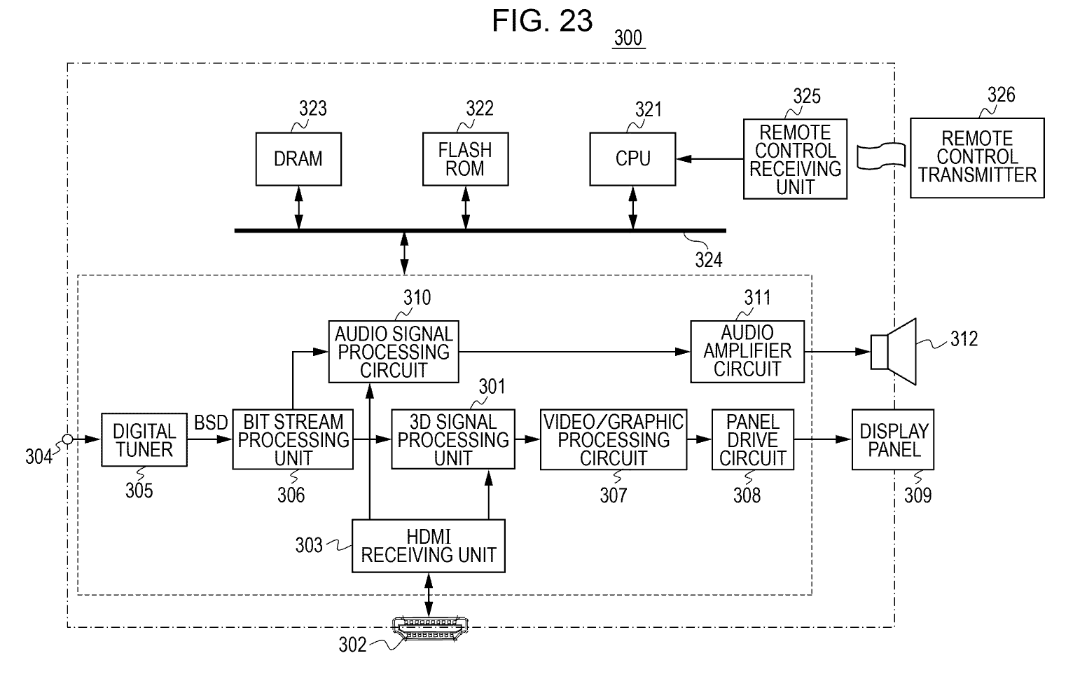

FIG. 22 illustrates an example configuration of the bit stream processing unit 201. The bit stream processing unit 201 has a configuration corresponding to the above-described transmission data generating unit 110 illustrated in FIG. 2. The bit stream processing unit 201 includes a demultiplexer 221, a video decoder 222, a caption decoder 223, a stereo-image caption producing unit 224, a disparity information retrieving unit 225, a video superimposing unit 226, and an audio decoder 227.

The demultiplexer 221 extracts packets of video, audio, and captions from the bit stream data BSD, and transmits them to the respective decoders. The video decoder 222 performs an inverse process of the process performed by the above-described video encoder 113 of the transmission data generating unit 110. That is, the video decoder 222 reconstructs a video elementary stream from the video packets extracted by the demultiplexer 221, performs a decoding process, and obtains stereo image data including left-eye image data and right-eye image data. Examples of the method for transmitting the stereo image data are the above-described first transmission method (“Top & Bottom” method), second transmission method (“Side By Side” method), third transmission method (“Frame Sequential” method), and the like (see FIGS. 4A to 4C).

The caption decoder 223 performs an inverse process of the process performed by the above-described caption encoder 133 of the transmission data generating unit 110. That is, the caption decoder 223 reconstructs a caption elementary stream (caption data stream) from the caption packets extracted by the demultiplexer 221, performs a decoding process, and obtains the pieces of caption data of respective caption units (caption data based on the ARIB method).

The disparity information retrieving unit 225 retrieves disparity vectors (disparity information) corresponding to the respective caption units from the caption stream obtained through the caption decoder 223. In this case, the disparity vectors of the respective caption units (individual disparity vectors) or a disparity vector common to the individual caption units (common disparity vector) is obtained (see FIGS. 11A to 13D). As described above, in the caption data stream, the pieces of data of a certain number of caption units to be displayed on the same screen are sequentially arranged. Also, disparity vectors (disparity information) are inserted as management information of the respective caption units into the caption data stream. Thus, the disparity information retrieving unit 225 can retrieve the disparity vectors in association with the pieces of caption data of the respective caption units.

The stereo-image caption producing unit 224 generates the data of a left-eye caption and a right-eye caption to be superimposed on a left-eye image and a right-eye image, respectively. This generation process is performed on the basis of the pieces of caption data of the respective caption units obtained by the caption decoder 223 and the disparity vectors (the values of the disparity vectors) corresponding to the respective caption units supplied from the disparity information retrieving unit 225. Then, the stereo-image caption producing unit 224 outputs the data (bitmap data) of the left-eye caption and the right-eye caption.

In this case, the captions (caption units) for a left eye and a right eye are the same information. However, the superimposition position in the image of the right-eye caption is shifted by the disparity vector in the horizontal direction with respect to the left-eye caption, for example. Accordingly, a caption in which disparity adjustment has been performed in accordance with the perspective of individual objects in an image can be used as the same captions that are to be superimposed on the left-eye image and the right-eye image, so that the perspective consistency with the individual objects in the image can be maintained in display of this caption.

The video superimposing unit 226 superimposes the data (bitmap data) of captions for a left eye and a right eye produced by the stereo-image caption producing unit 224 on the stereo image data (left-eye image data and right-eye image data) obtained by the video decoder 222, thereby obtaining stereo image data to be displayed Vout. Then, the video superimposing unit 226 outputs the stereo image data to be displayed Vout to the outside of the bit stream processing unit 201.

Also, the audio decoder 227 performs an inverse process of the process performed by the above-described audio encoder 117 of the transmission data generating unit 110. That is, the audio decoder 227 reconstructs an audio elementary stream from the audio packets extracted by the demultiplexer 221, performs a decoding process, and obtains audio data Aout. Then, the audio decoder 227 outputs the audio data Aout to the outside of the bit stream processing unit 201.

The operation of the bit stream processing unit 201 illustrated in FIG. 22 will be briefly described. The bit stream data BSD output from the digital tuner 204 (see FIG. 21) is supplied to the demultiplexer 221. In the demultiplexer 221, packets of video, audio, and captions are extracted from the bit stream data BSD, and are supplied to the respective decoders.

In the video decoder 222, a video elementary stream is reconstructed from the video packets extracted by the demultiplexer 221, furthermore a decoding process is performed, and stereo image data including left-eye image data and right-eye image data is obtained. The stereo image data is supplied to the video superimposing unit 226.

Also, in the caption decoder 223, a caption elementary stream is reconstructed from the caption packets extracted by the demultiplexer 221, furthermore a decoding process is performed, and the pieces of caption data (caption data based on the ARIB method) of the respective caption units are obtained. The pieces of caption data of the respective caption units are supplied to the stereo-image caption producing unit 224.

In the disparity information retrieving unit 225, the disparity vectors (the values of the disparity vectors) corresponding to respective caption units are retrieved from the caption stream obtained through the caption decoder 223. In this case, the disparity vectors of the respective caption units (individual disparity vectors) or a disparity vector common to the respective caption units (common disparity vector) is obtained. The disparity vectors are supplied to the stereo-image caption producing unit 224.

In the stereo-image caption producing unit 224, the data (bitmap data) of a left-eye caption and a right-eye caption to be superimposed on a left-eye image and a right-eye image is generated on the basis of the pieces of caption data of the respective caption units and the disparity vectors corresponding to the respective caption units. In this case, the superimposition position in the image of the right-eye caption is shifted by the disparity vector in the horizontal direction with respect to the left-eye caption. The data of the left-eye caption and the right-eye caption is supplied to the video superimposing unit 226.

In the video superimposing unit 226, the data (bitmap data) of the left-eye caption and the right-eye caption produced by the stereo-image caption producing unit 224 is superimposed on the stereo image data obtained by the video decoder 222, so that stereo image data to be displayed Vout is obtained. The stereo image data to be displayed Vout is output to the outside of the bit stream processing unit 201.

Also, in the audio decoder 227, an audio elementary stream is reconstructed from the audio packets extracted by the demultiplexer 221, furthermore a decoding process is performed, and audio data Aout corresponding to the above-described stereo image data to be displayed Vout is obtained. The audio data Aout is output to the outside of the bit stream processing unit 201.

### Description of Television Receiver

Referring back to FIG. 1, the television receiver 300 receives stereo image data that is transmitted from the set top box 200 via the HDMI cable 400. The television receiver 300 includes a 3D signal processing unit 301. The 3D signal processing unit 301 performs a process (decoding process) corresponding to a transmission method on the stereo image data, thereby generating left-eye image data and right-eye image data.

### Example Configuration of Television Receiver

An example configuration of the television receiver 300 will be described. FIG. 23 illustrates an example configuration of the television receiver 300. The television receiver 300 includes the 3D signal processing unit 301, an HDMI terminal 302, an HDMI receiving unit 303, an antenna terminal 304, a digital tuner 305, and a bit stream processing unit 306.

Also, the television receiver 300 includes a video/graphic processing circuit 307, a panel drive circuit 308, a display panel 309, an audio signal processing circuit 310, an audio amplifier circuit 311, and a speaker 312. Also, the television receiver 300 includes a CPU 321, a flash ROM 322, a DRAM 323, an internal bus 324, a remote control receiving unit 325, and a remote control transmitter 326.

The antenna terminal 304 is a terminal for inputting a television broadcast signal that is received by a receiving antenna (not illustrated). The digital tuner 305 processes the television broadcast signal input to the antenna terminal 304, and outputs certain bit stream data (transport stream) BSD corresponding to a channel selected by a user.

The bit stream processing unit 306 is configured similarly to the bit stream processing unit 201 in the set top box 200 illustrated in FIG. 21. The bit stream processing unit 306 extracts stereo image data, audio data, pieces of caption data of caption units, disparity vectors, etc., from the bit stream data BSD. Also, the bit stream processing unit 306 combines the data of a left-eye caption and a right-eye caption with the stereo image data, thereby generating stereo image data to be displayed and outputting it. Also, the bit stream processing unit 306 outputs audio data.

The HDMI receiving unit 303 receives uncompressed image data and audio data that are supplied to the HDMI terminal 302 via the HDMI cable 400 through the communication compatible with HDMI. The version of the HDMI receiving unit 303 is HDMI 1.4a, for example, and is in a state of being able to handle stereo image data.

The 3D signal processing unit 301 performs a decoding process on the stereo image data that is received by the HDMI receiving unit 303 or that is obtained by the bit stream processing unit 306, thereby generating left-eye image data and right-eye image data. In this case, the 3D signal processing unit 301 performs a decoding process corresponding to the transmission method (see FIGS. 4A to 4C) on the stereo image data obtained by the bit stream processing unit 306. Also, the 3D signal processing unit 301 performs a decoding process corresponding to a TMDS transmission data structure on the stereo image data received by the HDMI receiving unit 303.

The video/graphic processing circuit 307 generates image data for displaying a stereo image on the basis of the left-eye image data and right-eye image data generated by the 3D signal processing unit 301. Also, the video/graphic processing circuit 307 performs an image quality adjustment process on the image data as necessary. Also, the video/graphic processing circuit 307 combines the data of superimposition information, such as a menu and a program table, with the image data as necessary. The panel drive circuit 308 drives the display panel 309 on the basis of the image data output from the video/graphic processing circuit 307. The display panel 309 is constituted by a liquid crystal display (LCD), a plasma display panel (PDP), or the like.

The audio signal processing circuit 310 performs a necessary process, such as D/A conversion, on the audio data that is received by the HDMI receiving unit 303 or that is obtained by the bit stream processing unit 306. The audio amplifier circuit 311 amplifies an audio signal output from the audio signal processing circuit 310 and supplies it to the speaker 312.

The CPU 321 controls the operation of the individual units of the television receiver 300. The flash ROM 322 stores control software and stores data. The DRAM 323 forms a work area of the CPU 321. The CPU 321 expands software and data read from the flash ROM 322 on the DRAM 323 and starts the software, and controls the individual units of the television receiver 300.

The remote control receiving unit 325 receives a remote control signal (remote control code) transmitted from the remote control transmitter 326, and supplies it to the CPU 321. The CPU 321 controls the individual units of the television receiver 300 on the basis of this remote control code. The CPU 321, the flash ROM 322, and the DRAM 323 are connected to the internal bus 324.

The operation of the television receiver 300 illustrated in FIG. 23 will be briefly described. The HDMI receiving unit 303 receives stereo image data and audio data that are transmitted from the set top box 200 connected to the HDMI terminal 302 via the HDMI cable 400. The stereo image data received by the HDMI receiving unit 303 is supplied to the 3D signal processing unit 301. Also, the audio data received by the HDMI receiving unit 303 is supplied to the audio signal processing circuit 310.

A television broadcast signal input to the antenna terminal 304 is supplied to the digital tuner 305. The digital tuner 305 processes the television broadcast signal, and outputs certain bit stream data (transport stream) BSD corresponding to a channel selected by a user.

The bit stream data BSD output from the digital tuner 305 is supplied to the bit stream processing unit 306. In the bit stream processing unit 306, stereo image data, audio data, the pieces of caption data of caption units, disparity vectors, etc., are extracted from the bit stream data BSD. Also, in the bit stream processing unit 306, the data of a left-eye caption and a right-eye caption is combined with the stereo image data, so that stereo image data to be displayed is generated.

The stereo image data to be displayed that is generated by the bit stream processing unit 306 is supplied to the 3D signal processing unit 301. Also, the audio data obtained by the bit stream processing unit 306 is supplied to the audio signal processing circuit 310.

In the 3D signal processing unit 301, a decoding process is performed on the stereo image data that is received by the HDMI receiving unit 303 or that is obtained by the bit stream processing unit 306, so that left-eye image data and right-eye image data are generated. The left-eye image data and the right-eye image data are supplied to the video/graphic processing circuit 307. In the video/graphic processing circuit 307, image data for displaying a stereo image is generated on the basis of the left-eye image data and the right-eye image data, and an image quality adjustment process and a process of combining superimposition information data are performed as necessary.

The image data obtained by the video/graphic processing circuit 307 is supplied to the panel drive circuit 308. Accordingly, a stereo image is displayed on the display panel 309. For example, left-eye images based on the left-eye image data and right-eye images based on the right-eye image data are alternately displayed on the display panel 309 in a time division manner. A viewer can view only the left-eye images with a left eye and can view only the right-eye images with a right eye by wearing shutter glasses in which a left-eye shutter and a right-eye shutter alternately open in synchronization with display on the display panel 309, thereby being able to perceive a stereo image.

Also, in the audio signal processing circuit 310, a necessary process, such as D/A conversion, is performed on the audio data that is received by the HDMI receiving unit 303 or that is obtained by the bit stream processing unit 306. The audio data is amplified by the audio amplifier circuit 311 and is then supplied to the speaker 312. Accordingly, the audio corresponding to an image displayed on the display panel 309 is output from the speaker 312.

As described above, in the stereo image display system 10 illustrated in FIG. 1, a multiplexed data stream including a video data stream and a caption data stream is transmitted from the broadcast station 100 (transmission data generating unit 110) to the set top box 200. The video data stream includes stereo image data. Also, the caption data stream includes the pieces of data of captions (caption units) based on the ARIB method as superimposition information and disparity vectors (disparity information).

In the caption data stream, the pieces of caption data of a certain number of caption units that are to be displayed on the same screen are sequentially arranged. Also, disparity vectors (disparity information) are inserted as the management information of the respective caption units into this caption data stream, and the pieces of caption data of the respective caption units are associated with the disparity vectors.

Thus, in the set top box 200, appropriate disparity can be given using the corresponding disparity vectors (disparity information) to the certain number of caption units (captions) that are to be superimposed on a left-eye image and a right-eye image. Thus, the perspective consistency with individual objects in an image can be maintained in the optimum state in display of the caption units (captions).

### 2. Modification

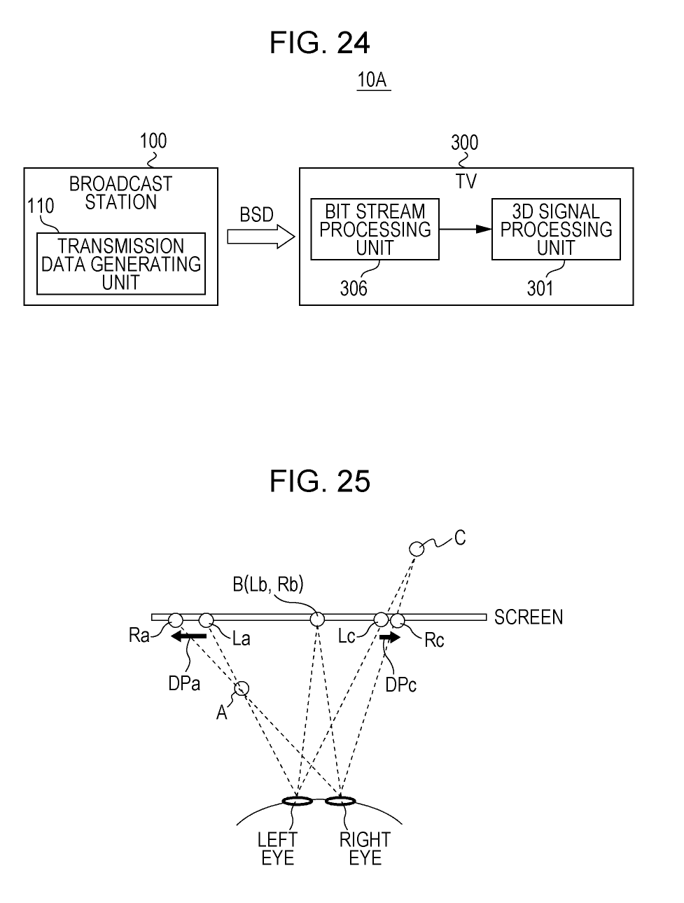

In the above-described embodiment, the stereo image display system 10 is constituted by the broadcast station 100, the set top box 200, and the television receiver 300. However, the television receiver 300 is provided with the bit stream processing unit 306 that functions equivalently to the bit stream processing unit 201 in the set top box 200, as illustrated in FIG. 23. Thus, a stereo image display system 10A constituted by the broadcast station 100 and the television receiver 300 is also available, as illustrated in FIG. 24.

Also, in the above-described embodiment, an example in which a data stream (bit stream data) including stereo image data is broadcasted by the broadcast station 100 has been described. However, the present disclosure can also be applied to a system having a configuration in which this data stream is distributed to a reception terminal using a network, such as the Internet.

Also, in the above-described embodiment, the set top box 200 is connected to the television receiver 300 via a digital interface of HDMI. However, the present disclosure can also be applied to a case where those are connected via a digital interface (including wireless as well as wired) similar to the digital interface of HDMI.

Also, in the above-described embodiment, caption units (captions) are handled as superimposition information. Alternatively, other superimposition information, such as graphics information or text information, may also be applied.

It should be understood by those skilled in the art that various modifications, combinations, sub-combinations and alterations may occur depending on design requirements and other factors insofar as they are within the scope of the appended claims or the equivalents thereof.

What is claimed is:

1. A stereo image data transmitting apparatus comprising:
an image data output unit configured to output stereo image data including left-eye image data and right-eye image data;
a superimposition information data output unit configured to output data of superimposition information that is to be superimposed on images based on the left-eye image data and the right-eye image data;
a disparity information output unit configured to output disparity information for giving disparity by shifting the superimposition information that is to be superimposed on the images based on the left-eye image data and the right-eye image data; and
a data transmitting unit configured to transmit a multiplexed data stream including a first data stream and a second data stream, the first data stream including the stereo image data output from the image data output unit, the second data stream including the data of the superimposition information output from the superimposition information data output unit and the disparity information output from the disparity information output unit,
wherein pieces of data of a certain number of pieces of superimposition information that are to be displayed on the same screen are sequentially arranged in the second data stream, and
wherein the disparity information is inserted as management information of the certain number of pieces of superimposition information into the second data stream.

2. The stereo image data transmitting apparatus according to claim 1,
wherein a certain number of pieces of individual disparity information corresponding to the certain number of pieces of superimposition information that are to be displayed on the same screen are inserted into the second data stream, and
wherein all the certain number of pieces of individual disparity information are arranged before the pieces of data of the certain number of pieces of superimposition information.

3. The stereo image data transmitting apparatus according to claim 1,
wherein a certain number of pieces of individual disparity information corresponding to the certain number of pieces of superimposition information that are to be displayed on the same screen are inserted into the second data stream, and
wherein each of the certain number of pieces of individual disparity information is arranged before the piece of data of the corresponding piece of the superimposition information.

4. The stereo image data transmitting apparatus according to claim 1,
wherein common disparity information corresponding to the certain number of pieces of superimposition information that are to be displayed on the same screen is inserted into the second data stream, and
wherein the common disparity information is arranged before the pieces of data of the certain number of pieces of superimposition information.

5. The stereo image data transmitting apparatus according to claim 1,
wherein the data of the superimposition information is caption sentence data based on an ARIB method, and
wherein the disparity information is inserted as caption management data into the second data stream.

6. The stereo image data transmitting apparatus according to claim 5,
wherein the disparity information is given as an eight-unit code.

7. A stereo image data transmitting method comprising the steps of:
outputting stereo image data including left-eye image data and right-eye image data;
outputting data of superimposition information that is to be superimposed on images based on the left-eye image data and the right-eye image data;
outputting disparity information for giving disparity by shifting the superimposition information that is to be superimposed on the images based on the left-eye image data and the right-eye image data; and
transmitting a multiplexed data stream including a first data stream and a second data stream, the first data stream including the stereo image data output in the step of outputting stereo image data, the second data stream including the data of the superimposition information output in the step of outputting data of superimposition information and the disparity information output in the step of outputting disparity information,
wherein pieces of data of a certain number of pieces of superimposition information that are to be displayed on the same screen are sequentially arranged in the second data stream, and
wherein the disparity information is inserted as management information of the certain number of pieces of superimposition information into the second data stream.

8. A stereo image data receiving apparatus comprising:
a data receiving unit configured to receive a multiplexed data stream including a first data stream and a second data stream, the first data stream including stereo image data including left-eye image data and right-eye image data for displaying a stereo image, the second data stream including data of superimposition information that is to be superimposed on images based on the left-eye image data and the right-eye image data and disparity information for giving disparity by shifting the superimposition information that is to be superimposed on the images based on the left-eye image data and the right-eye image data, pieces of data of a certain number of pieces of superimposition information that are to be displayed on the same screen being sequentially arranged in the second data stream, the disparity information being inserted as management information of the certain number of pieces of superimposition information into the second data stream;
an image data obtaining unit configured to obtain the stereo image data from the first data stream included in the multiplexed data stream received by the data receiving unit;
a superimposition information data obtaining unit configured to obtain the data of the superimposition information from the second data stream included in the multiplexed data stream received by the data receiving unit;
a disparity information obtaining unit configured to obtain the disparity information from the second data stream included in the multiplexed data stream received by the data receiving unit; and
an image data processing unit configured to give disparity to the same superimposition information that is to be superimposed on a left-eye image and a right-eye image using the left-eye image data and the right-eye image data included in the stereo image data obtained by the image data obtaining unit, the disparity information obtained by the disparity information obtaining unit, and the data of the superimposition information obtained by the superimposition information data obtaining unit, thereby obtaining data of the left-eye image on which the superimposition information is superimposed and data of the right-eye image on which the superimposition information is superimposed.

9. A stereo image data receiving method comprising the steps of:
receiving a multiplexed data stream including a first data stream and a second data stream, the first data stream including stereo image data including left-eye image data and right-eye image data for displaying a stereo image, the second data stream including data of superimposition information that is to be superimposed on images based on the left-eye image data and the right-eye image data and disparity information for giving disparity by shifting the superimposition information that is to be superimposed on the images based on the left-eye image data and the right-eye image data, pieces of data of a certain number of pieces of superimposition information that are to be displayed on the same screen being sequentially arranged in the second data stream, the disparity information being inserted as management information of the certain number of pieces of superimposition information into the second data stream;
obtaining the stereo image data from the first data stream included in the multiplexed data stream received in the step of receiving a multiplexed data stream;
obtaining the data of the superimposition information from the second data stream included in the multiplexed data stream received in the step of receiving a multiplexed data stream;
obtaining the disparity information from the second data stream included in the multiplexed data stream received in the step of receiving a multiplexed data stream; and
giving disparity to the same superimposition information that is to be superimposed on a left-eye image and a right-eye image using the left-eye image data and the right-eye image data included in the stereo image data obtained in the step of obtaining the stereo image data, the disparity information obtained in the step of obtaining the disparity information, and the data of the superimposition information obtained in the step of obtaining the data of the superimposition information, thereby obtaining data of the left-eye image on which the superimposition information is superimposed and data of the right-eye image on which the superimposition information is superimposed.
